(19) United States
(12) Patent Application Publication
(10) Pub. No.: US 2026/0347228 A1
(43) Pub. Date: Nov. 5, 2026

(54) HYBRID GLASS PRODUCTION FURNACE WITH ENERGY FLEXIBILITY AND METHOD FOR PRODUCING GLASS

(71) Applicant: SAINT-GOBAIN GLASS FRANCE, COURBEVOIE (FR)

(72) Inventors: Aurélien SAGET, COURBEVOIE (FR); Jean-Marie COMBES, COURBEVOIE (FR); Arnaud LE VERGE, COURBEVOIE (FR); Yves LITOUT, COURBEVOIE (FR); Nicole POUSSINEAU, COURBEVOIE (FR)

(21) Appl. No.: 19/112,494

(22) PCT Filed: Sep. 21, 2023
(86) PCT No.: PCT/EP2023/076060

§ 371 Date: Mar. 17, 2025

(30) Foreign Application Priority Data
Sep. 22, 2022 (EP) 22306392.6

(51) Int. Cl. C03B 5/03; C03B 3/00; C03B 5/04; C03B 5/225; C03B 5/24; C03B 5/26; C03B 7/06

(52) U.S. Cl. CPC C03B 5/03; C03B 3/00; C03B 5/04; C03B 5/225; C03B 5/24; C03B 5/267; C03B 7/06

(57) ABSTRACT

A hybrid furnace for producing glass, in particular for supplying a float unit, the hybrid furnace having a longitudinal axis including at least one electric melting zone including electrodes which is suitable for being supplied with a vitrifiable mixture by a first charging device; a flame melting zone including at least overhead burners which is suitable for being supplied with a vitrifiable mixture by a second charging device, separate from the at least one first charging device, wherein the at least one electric melting zone and the flame melting zone, which are arranged in series, are configured to be able to operate independently of one another so as to allow selective use of either or both of the melting zones, thereby granting the furnace energy flexibility.

### TECHNICAL FIELD OF THE INVENTION

The invention relates to a hybrid furnace for producing glass in particular with energy flexibility and to a method for producing glass implemented in such a hybrid furnace.

The invention relates more particularly to a hybrid furnace for producing glass comprising at least one electric melting zone and one flame melting zone which, being independent of one another, can be used selectively, jointly or not, whereby the furnace offers energy flexibility by allowing at least one energy source such as electricity and/or fuel to be selected for melting the vitrifiable mixture to obtain molten glass, which then flows into a refining zone with two convection loops so as to obtain suitable quantities of a high-quality glass.

Indeed, the hybrid furnace according to the invention is not only capable of providing energy flexibility, but also of delivering high-quality glass with less than 0.1 bubbles per liter, with a pull rate of at least 400 tons per day, preferentially between 600 and 900 tons per day, or even 1,000 tons per day or more, in particular to supply a glass float unit on a molten metal bath for the manufacture of flat glass.

The invention also relates to a method for producing glass implemented in such a hybrid furnace comprising at least one step of melting a vitrifiable mixture carried out in at least one electric melting zone and/or a flame melting zone of the hybrid furnace.

### STATE OF THE ART

Different example designs of furnaces for the manufacture of glass that depend in particular on the product to be manufactured, that is to say the final shaping of the glass, are known from the prior art.

Thus, different furnace designs are distinguished depending on whether the planned production relates to glass fibers, industrial hollow glass forming, or flat glass.

One of the industrial challenges in the design of glass furnaces is to be able to obtain a glass whose quality requirements depend on the product. In this respect, flat glass production is comparatively one of the most demanding.

Produced in very large quantities, flat glass is used in a wide range of applications thanks to its versatility. It is widely used in the electronics (flat screens), construction and automotive sectors, where it can be processed using a wide variety of techniques (bending, tempering, etc.), making it the base glass for a whole range of glass products.

In view of the quality and quantity issues involved, the present invention is particularly aimed at the manufacture of glass for the industrial forming of such flat glass, which is conventionally obtained by means of a glass float unit on a bath of molten metal, generally tin, which is why such flat glass is still called float glass.

For the manufacture of flat glass, it is expected to be able to feed the float unit with high quality glass, i.e. glass containing as few bubbles as possible, i.e. generally glass with less than 0.5 bubbles/liter.

Glass quality is determined in particular, but not exclusively, by the number of bubbles present in the glass, expressed in “bubbles per liter”. The lower the number of bubbles per liter in a glass, the higher its quality is considered to be.

It should also be remembered that the presence of bubbles (or gaseous defects) in glass is inherent to the glassmaking process, wherein there are generally three successive stages or phases: melting, refining and homogenizing, and thermal conditioning of the glass.

The presence of bubbles in the glass results in the melting step during which a vitrifiable mixture is melted, also called a “composition”. The vitrifiable mixture is made up of raw materials comprising, for example, a mixture of sand, limestone (calcium carbonate), soda ash and dolomite for the manufacture of soda-lime glass (the glass most commonly used for flat glass manufacture), to which cullet is advantageously added, made up of broken glass in order to promote melting.

The vitrifiable mixture is transformed into a liquid mass wherein even the least miscible particles, that is, those richest in silicon dioxide or silica (SiO₂) and lowest in sodium oxide (Na₂O), dissolve.

Sodium carbonate (Na₂CO₃) begins to react with grains of sand at 775 °C, releasing bubbles of carbon dioxide (CO₂) into a liquid that becomes increasingly viscous as the carbonate transforms into silicate. Likewise, the transformation of limestone grains into lime and the breakdown of dolomite also cause the emission of carbon dioxide (CO₂).

The melting stage is completed when there are no more solid particles in the molten glass liquid, which has become highly viscous and, at this stage of the manufacturing process, is filled with air and gas bubbles.

The refining and homogenization step then makes it possible to eliminate the bubbles present in the molten glass. As is well known, “refining agents” are advantageously used during this stage, that is, substances in low concentration which, by breaking down at the bath's melting temperature, supply gases which cause the bubbles to swell, thus accelerating their ascent to the surface of the glass.

The thermal conditioning stage of the manufacturing process then makes it possible to lower the temperature of the glass since, at the start of the shaping operation, the viscosity of the glass must generally be at least ten times higher than during refining.

Each of the steps of manufacturing the glass that have just been described naturally corresponds to the structure of a furnace used to carry them out.

Typically, a glass furnace of this type comprises a melting zone wherein the glass batch is melted to form a glass bath, followed by a refining and homogenizing zone to eliminate glass bubbles, and finally a thermal conditioning zone to cool the glass to its forming temperature, which is much lower than the temperatures experienced by the glass during its production.

From the glassmaking process mentioned above, we can see that the melting stage is accompanied by the emission of carbon dioxide (CO₂), one of the main greenhouse gases involved in climate change.

For this reason, efforts are being made to use an ever-increasing proportion of cullet in order to reduce these direct carbon dioxide (CO₂) emissions, as well as the indirect carbon dioxide (CO₂) emissions associated with the raw materials used in the vitrifiable mixture.

Indeed, apart from manufacturing of a high-quality glass, as well as industrial challenges of high productivity with the lowest possible cost of furnace construction and operation, one of the other major current challenges which the glass industry must face is ecological, namely the need to find solutions to reduce the carbon footprint (or CO2 footprint) of the process for producing the glass.

To achieve carbon neutrality, a global approach to the process is preferred, seeking to act in multiple ways to reduce both direct emissions during manufacturing and indirect emissions, as well as upstream and downstream emissions in the value chain, for example those linked to the transport of materials upstream and the product downstream.

These multiple ways therefore include product design and material composition, improving the energy efficiency of industrial processes, using renewable and decarbonized energy, working with raw material suppliers and transporters to reduce their emissions, and finally, exploring technologies for capturing and sequestering residual emissions.

In addition to the direct emissions inherent in the glassmaking process mentioned above, the type of energy used, particularly for the high-temperature melting stage (over 1500 °C), accounts for the largest share of the carbon footprint of the glassmaking process, since it generally involves fossil fuels, most often natural gas or even petroleum products such as fuel oil.

Consequently, research into new furnace designs must not only meet the industrial challenges associated with glass quality, but also reduce the carbon footprint of the glassmaking process, in terms of both direct and indirect carbon dioxide (CO₂) emissions, notably by reducing the use of fossil fuels.

Glass is manufactured in furnaces which have not stopped evolving since the first pot (or crucible) furnaces, through the Siemens furnace, which is usually considered to be the forerunner of the modern-day large continuous-cast glass furnaces, like cross-fired furnaces which can produce up to 1200 tons of float glass per day.

The choice of energy used for the melt thus leads to two common large furnace designs for the manufacture of glass, respectively flame furnaces and electric furnaces.

According to the first design, flame furnaces generally use fossil fuels, in particular natural gas for burners; the thermal energy is thus transmitted to the glass by heat exchange between the flames and the surface of the glass bath.

The above-mentioned cross-fired furnaces are an example of a furnace that goes by this first design, and are widely used to supply molten glass to a float unit intended to manufacture flat glass.

According to the second design, electric furnaces are ones wherein the thermal energy is produced by the Joule effect within the mass of the molten glass.

Indeed, an insulating substance at room temperature, the glass becomes electrically conductive at high temperature so that it is possible to envisage using the Joule effect within the glass melts to heat them.

However, electric furnaces are, for example, used for the production of particular glasses such as opal glass with fluorine or lead crystal or are commonly used for the manufacture of glass fibers for thermal insulation.

Indeed, it is commonly accepted by a person skilled in the art that such electric furnaces are not able to supply glass in sufficient quantity or quality (as a reminder less than 0.5 bubble per liter) to a float glass unit on a bath of molten metal intended for the manufacture of flat glass.

Electric furnaces of the prior art known by the Applicant are at most capable of delivering a pull rate of 200 to 250 tonnes per day of a glass which has at best a few hundred bubbles per liter, more generally a few thousand, which may possibly be suitable for forming hollow glasses, typically bottles, but is in no way the case for the manufacture of flat glass and consequently for supplying a float unit.

It is the reason why flame furnaces (such as cross-fired furnaces) remain today only the furnaces capable of supplying such a float glass unit.

However, flame furnaces rely on the use of fossil fuels, essentially natural gas, so that their carbon footprint is hardly compatible with the objectives of reducing carbon dioxide (CO₂) emissions, i.e. the carbon footprint of the glass production process.

In order to complete the description of furnace designs for manufacturing glass according to the prior art, mention will be made of a “third design” of a furnace, having recently known changes to face in particular to the ecological issue of reducing carbon dioxide emissions (CO₂).

This third furnace design is based on a flame furnace, but uses electrical booster heating, in particular to momentarily increase the production of the furnace or to improve the quality of the glass.

Therefore, such furnaces are also called “electric-boosted flame furnaces”.

The furnaces according to this third design thus combine several sources of energy, respectively fossil fuels and electricity, and are therefore also called “hybrid” furnaces.

Adding electrical booster heating makes it possible to improve the melting capacity of flame furnaces which is limited by the heat transfer occurring between the flame and the surface of the glass bath.

However, the operation of such a hybrid furnace is always mainly based on the use of a fossil fuel, typically gas, so that the impact ultimately obtained on improving the carbon footprint of the glass production process remains limited. Indeed, the electricity is used here only as a booster, so that its impact is proportional.

In addition, in order to effectively improve the carbon footprint, the electricity used must still be a so-called “green” electricity, that is, electricity that is produced from sources of renewable and decarbonized energy.

Note that the above comment on electricity applies equally to fuels such as bio-methane or hydrogen, which can be used to replace natural gas in burners.

While improving the carbon footprint of the glassmaking process is a crucial issue, as demonstrated by market players' commitments to producing “zero-carbon” glass, controlling manufacturing costs is also a major concern.

Since glassmaking is particularly energy-intensive, especially the melting stage of the vitrifiable mixture, the choice of energy used in a glassmaking furnace is a decisive factor both economically and ecologically.

Generally speaking, energy costs follow the law of the market, varying according to supply and demand, although it should be noted that depending on the type of energy (gas, oil, etc.) used directly or transformed into electricity, resources are unevenly distributed across the planet, so that geopolitical issues such as war are in particular likely to affect them greatly.

When it comes to designing new furnaces for glassmaking, energy choices are of the utmost importance and come up against a host of uncertainties, not least the economic risks associated with energy costs, and even its availability in sufficient quantities to meet the ecological challenges of “zero-carbon” glassmaking.

The aim of the invention is also to propose a new furnace design for producing glass that limits the economic risks associated with the choice of energy, while at the same time being able to deliver glass that is of high quality on the one hand and in the required quantity on the other, in particular suitable for supplying a glass float unit intended to produce flat glass, and enabling a reduction in carbon dioxide (CO₂) emissions associated with the glassmaking process to be achieved.

### BRIEF SUMMARY OF THE INVENTION

For this purpose, the invention proposes a hybrid glass manufacturing furnace, in particular for supplying a unit for floating the glass on a molten metal bath, said hybrid furnace having a longitudinal axis comprising:
at least one electric melting zone which is suitable for being supplied with a vitrifiable mixture by at least one first charging device and which comprises electrodes for melting said vitrifiable mixture;
a flame melting zone which, separate from said at least one electric melting zone, is suitable for being supplied with a vitrifiable mixture by at least one second charging device and which comprises at least overhead burners for melting said vitrifiable mixture, said overhead burners being arranged above the surface of the molten glass,
wherein said at least one electric melting zone and said flame melting zone are arranged in series so that the molten glass produced by one of said upstream melting zones is capable of flowing into the other of said downstream melting zones, and wherein said at least one electric melting zone and said flame melting zone are configured to operate independently of one another so as to allow selective use of either or both of said melting zones in order to provide the furnace with energy flexibility,
a refining zone for molten glass delivered by said at least one electric melting zone and/or said flame melting zone, said refining zone being configured to include a first convection loop and a second convection loop; and
a zone for cooling the glass including a conditioning tank which is passed through by the second convection loop and which is connected to at least one glass flow channel.

Advantageously, the hybrid furnace according to the invention is characterized by the fact that it comprises at least two melting zones which, separate and independent of one another, are able to operate selectively with a different energy source.

Advantageously, the hybrid furnace respectively includes at least a first melting zone using a first energy and a second melting zone using a second energy source which is different from the first energy source, owing to which it is possible to selectively use a first energy and/or a second energy to the benefit in particular of energy flexibility for glass manufacture.

Preferably, the first energy is electricity and the second energy is a fuel.

Advantageously, the design of the hybrid furnace according to the invention allows total energy flexibility, with the possibility of using either only one of said at least one electric melting zone and flame melting zone of the furnace, or both said electric and flame melting zones in configurable proportions, to melt the vitrifiable mixture.

In this way, the hybrid furnace offers several operating modes in terms of the choice of energy used to melt the vitrifiable mixture, that is, more generally multimode operation, with the operating mode of the selected hybrid furnace being determined based on at least one selection parameter comprising one or more criteria.

For each glass production process, it may be desired at any given moment to give priority to at least one criterion, or even to seek the best compromise according to several criteria, such as economic, ecological or even technical criteria.

The economic criterion of energy cost is just one of the criteria that can be taken into account when making a choice, as are ecological criteria such as the carbon footprint (CO₂) of the energy used, and even one or more technical criteria.

When said electric and flame melting zones are used together, there is again flexibility, since the proportion of molten glass that can be produced by each of them can be freely parameterized, in particular by acting on the associated charging devices and the heating means for melting, that is, the electrodes and overhead burners.

Thus, the electricity used to power the electrodes and the fuel used to power the overhead burners may or may not be equally involved, for example in a 50/50 ratio (that is, 50% each). Electricity can also be predominant over fuel (or vice versa), for example with a ratio of 80/20 (that is, 80% electricity and 20% fuel) or any other ratio such as 70/30 or 60/40.

In such an operating mode, known as hybrid, the charging devices respectively associated with each of said electric and flame melting zones then supply them with vitrifiable mixture in proportion, selectively, and in so doing the charging devices also participate in obtaining the energy flexibility of a hybrid furnace according to the invention.

In a hybrid furnace according to the invention, the maximum pull rate of the at least one electric melting zone and that of the flame melting zone are determined by design and can each be dimensioned to deliver a pull rate that is equal to the desired nominal pull rate for the furnace, so that this nominal pull rate can be achieved even when only one of said melting zones is used, that is, a single energy source for melting, electricity or fuel.

However, it is also possible to size at least one of said furnace melting zones so that its maximum pull rate is less than the nominal pull rate of the furnace, thus benefiting from a reduction in the dimensions of said at least one melting zone. In this case, the nominal pull rate of the furnace can only be reached by using the electric and flame melting zones together, or by using the other melting zone if it is dimensioned to deliver a maximum pull rate equal to the furnace's nominal pull rate.

Owing to the design of the hybrid furnace according to the invention, offering such a multimode operation guaranteeing energy flexibility, it is possible to significantly reduce the risks associated with the choice of a given energy whose costs and availability are likely to vary greatly on the markets, notably based on the supply/demand ratio, throughout the operating life of the furnace.

By comparison with the invention, it will be understood that in a furnace according to the state of the art wherein the melting of the vitrifiable mixture is achieved with a single energy, typically fuel for the first design or electricity for the second design, there is no energy flexibility.

In the event of a major increase in the cost of the energy used for melting, or of its unavailability, the consequences can go so far as to jeopardize glass production, leading to a furnace shutdown.

This also applies to a hybrid furnace according to the third design, even though fuel and electricity (as a booster) are used, since molten glass production cannot be achieved with a single energy source in such a furnace, in particular not with electricity only.

Generally speaking, it should be remembered that building a furnace for glass production is a very costly investment, and that it takes a long time to amortize the cost of operating such a furnace, generally more than twenty years, which also necessarily influences the choices made when building a furnace.

However, the energy flexibility offered by a hybrid furnace according to the invention is only one of the advantages, since the design of the furnace also makes it possible to obtain very high quality glass, manufactured in the quantities required to supply a float glass unit for the manufacture of flat glass, by far the most demanding application.

The series arrangement of said at least one electric melting zone and the flame melting zone relative to one another advantageously favors mixing of the molten glass delivered by each when said zones are used together in the hybrid operating mode.

Owing to the series arrangement of said at least one electric melting zone and said flame melting zone, the molten glass produced by one of said upstream melting zones is able to flow into the other of said downstream melting zones, thus promoting glass mixing, notably due to the temperature of the glass present in each of said melting zones.

In addition to said series arrangement, the two glass convection loops also contribute to obtaining a very high quality glass with less than 0.1 bubbles per liter, in particular the first convection loop which extends into the flame melting zone and the refining zone.

Advantageously, the hybrid furnace comprises a tank neck interconnecting said at least one electric melting zone and said flame melting zone.

In a hybrid furnace according to the invention, owing to said non-return glass separation device advantageously arranged in the tank neck, no convection loops or glass recirculation loops extend from the flame melting zone to the electric melting zone, whether or not the electric melting zone is used.

By comparison, an immersed throat connecting an electric melting zone to a flame melting zone would be unable to ensure such a function of preventing the glass from returning in a furnace. Indeed, a return current of the glass necessarily exists in a throat, in particular due to the wear of the materials.

In addition, the glass flowing in a throat is not in contact with the atmosphere so that it is also not capable of being cooled in a controlled and variable manner on the surface, in particular by cooling means such as an air circulation cooling device.

A tank neck advantageously enables bubbles present in the glass to be evacuated to the surface, unlike a throat wherein the bubbles are trapped in the glass. In addition, contact between the bubbles and the refractories in the throat causes accelerated corrosion at the interface, resulting in premature wear of the throat and “chemical pollution” of the glass by the materials forming the refractories.

By comparison with a throat whose section is limited by construction, the tank neck additionally allows a flow of the glass with a pull rate able to supply a float unit.

Compared with a throat, the glass leaving a tank neck has a higher temperature because it is in the vicinity of the surface of the bath in the upstream melting zone from which it comes, as opposed to the glass at the floor. However, because of the overhead access to the glass, a tank neck can be used to cool the glass.

This cooling of the glass can be passive (mainly by radiation) or active (with cooling means), owing to which the temperature of the glass flowing into the tank neck is controlled, in particular with a view to obtaining optimum mixing with the glass present in the melting zone located downstream of the tank neck. Cooling the glass as obtained in the tank neck (with or without cooling means) is also particularly advantageous when the glass is produced by electric melting, as the molten glass generally has a high temperature (compared with that of flame melting), which may need to be reduced.

Further advantageous features of the invention are in particular the subject of the dependent claims.

### BRIEF DESCRIPTION OF THE FIGURES

Further features and advantages of the invention will become apparent upon reading the following detailed description, for the understanding of which reference is made to the appended drawings, wherein:

FIG. 1 is a cross-sectional view through a vertical plane along the longitudinal axis A-A′ of the furnace, showing a hybrid furnace for producing glass according to a first embodiment of the invention, comprising an independent electric melting zone and a flame melting zone, and showing said electric melting zone connected by a tank neck to the flame melting zone, which is connected to a refining zone comprising a first convection loop and a second convection loop, itself then connected to a cooling zone passed through by said second convection loop;

FIG. 2 is a horizontal cross-sectional view showing the furnace according to the first embodiment as seen from above, and also showing a first charging device for supplying the electric melting zone and a second charging device for supplying the flame melting zone, which melting zones are connected to one another by the tank neck comprising an “non-return” separation device configured to prevent molten glass from flowing back from the flame melting zone to the electric melting zone;

FIG. 3 is a cross-sectional view showing, in detail, the tank neck of the hybrid furnace according to FIG. 1 and showing a preferred example of said “non-return” separation device of the glass consisting of an elevation of the floor of the tank neck;

FIG. 4 is a cross-sectional view which, like FIG. 3, shows in detail the tank neck of the hybrid furnace and shows another example of the design of said “non-return” separation device of the glass comprising a movable dam and an elevation of the floor of the tank neck;

FIG. 5 is a cross-sectional view similar to FIG. 2, showing the furnace according to the first embodiment in a first electric melting operating mode and further showing the electric melting zone covered with a layer of vitrifiable mixture retained downstream by immobilizing means, the melting of which to obtain molten glass is carried out solely in said zone with electricity as the energy source;

FIG. 6 is a cross-sectional view analogous to FIG. 2, showing the furnace according to the first embodiment in a second hybrid operating mode wherein melting of the vitrifiable mixture is carried out jointly in the electric melting zone and in the flame melting zone, each supplied by separate charging devices, and showing the electric melting zone covered by a layer of vitrifiable mixture introduced by a first charging device and the flame melting zone covered by a layer of vitrifiable mixture introduced by a second charging device comprising two batch chargers;

FIG. 7 is a cross-sectional view analogous to FIG. 2, showing the furnace according to the first embodiment in a third flame-melting operating mode and further showing the flame melting zone covered with a layer of vitrifiable mixture, the melting of which to obtain molten glass is carried out by combustion in said zone provided with burners with a fuel for energy;

FIG. 8 is a cross-sectional view through a vertical plane along the longitudinal axis A-A′ of the furnace, showing a hybrid furnace for producing glass according to a second embodiment of the invention, including two electric melting zones and one flame melting zone, and showing said flame melting zone to which are respectively connected a first electric melting zone and a second electric melting zone arranged transversely, said flame melting zone being connected to a refining zone which, including a first convection loop and a second convection loop, is itself connected to a cooling zone passed through by said second convection loop;

FIG. 9 is a horizontal cross-sectional view of the hybrid furnace according to the second embodiment as seen from above, further showing the first electric melting zone and the second electric melting zone arranged transversely on both sides of the flame melting zone to which each of said zones is connected by a tank neck;

FIG. 10 is a cross-sectional view through a vertical plane along a transverse axis B-B′ shown in FIG. 9, which represents the hybrid furnace according to the second embodiment and which shows the first electric melting zone and the second electric melting zone respectively connected transversely to said flame melting zone by a first tank neck and by a second tank neck each comprising an “non-return” separation device of the glass, here analogous to that of FIG. 3;

FIG. 11 is a cross-sectional view similar to FIG. 9, showing the furnace according to the second embodiment in a first electric melting operating mode and further showing the first electric melting zone and the second electric melting zone, respectively, covered with a layer of vitrifiable mixture retained by immobilizing means, the melting of which to obtain molten glass is carried out solely in said zone with electricity as the energy source, without using the flame melting zone;

FIG. 12 is a cross-sectional view analogous to FIG. 9, depicting the furnace according to the second embodiment in a second hybrid operating mode, wherein melting of the vitrifiable mixture is carried out jointly in the first and second electric melting zones and in the flame melting zone, and showing the two electric melting zones covered with a layer of vitrifiable mixture introduced respectively by a first and a second batch charger of a first charging device, and the flame melting zone into which vitrifiable mixture is introduced by a second charging device which is separate from said first charging device.

### DETAILED DESCRIPTION OF THE FIGURES

In the remainder of the description, the longitudinal, vertical, and transverse orientations will be used without limitation in reference to the axis system (L, V, T) shown in the figures.

Use will also be made, without limitation, of the terms “upstream” and “downstream” when referring to the longitudinal direction, as well as “upper” and “lower” or “top” and “bottom” when referring to the vertical direction and finally “left” and “right” when referring to the transverse direction.

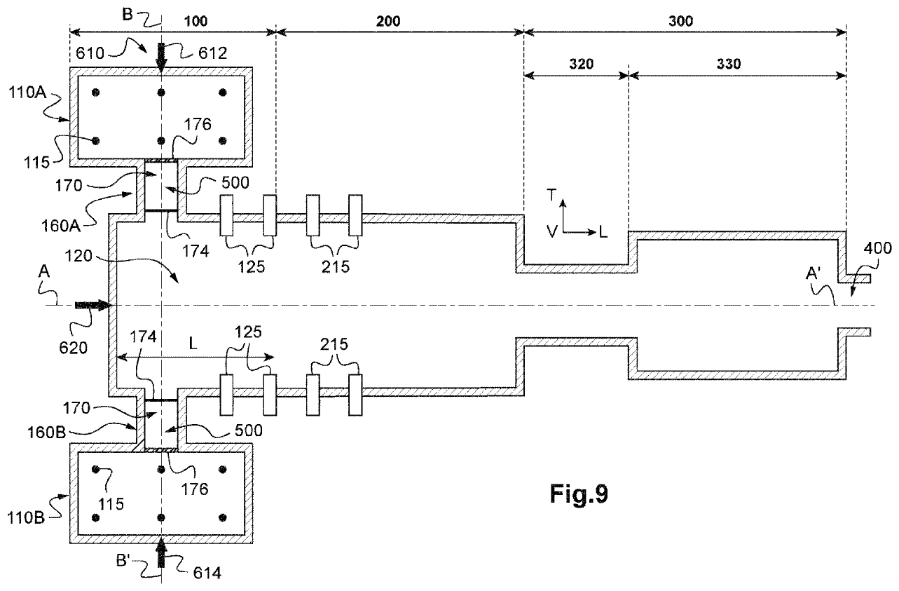

In the present description, the terms “upstream” and “downstream” correspond to the direction of flow of the glass in the furnace, the glass flowing from upstream to downstream along a longitudinal axis A-A′ of the hybrid furnace (upstream from A, downstream from A') as shown in particular in FIGS. 2 and 9.

Furthermore, the term “loop” is used here in connection with the recirculation of the glass in the furnace being well known to the person skilled in the art, just like the concepts of “cold top” and “hot top” for a glassmaking furnace.

The figures showing the hybrid furnace according to the invention are not to scale.

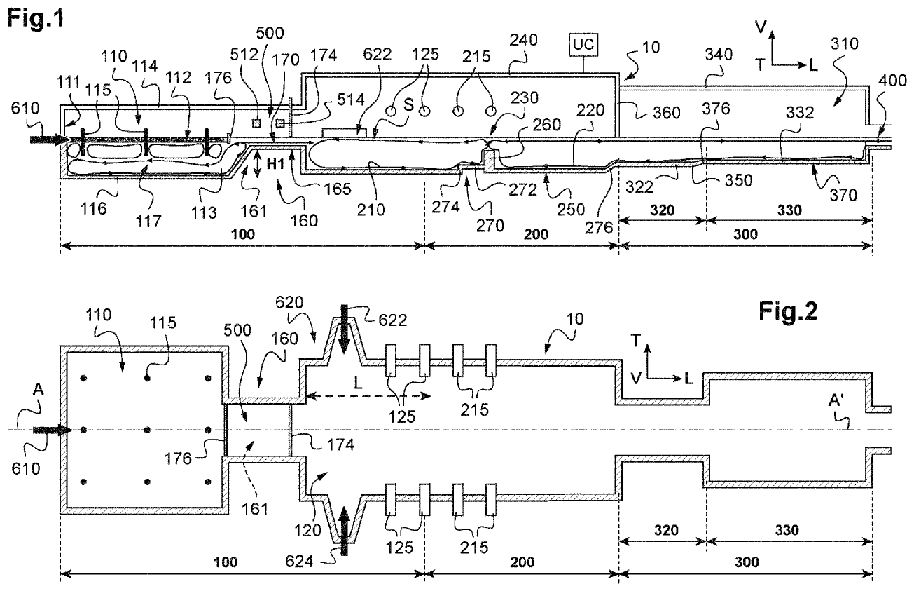

FIGS. 1 and 2 show cross-sectional views depicting, from the side and top, respectively, a hybrid furnace 10 for producing glass according to a first embodiment of the invention.

By analogy with the third furnace design described above, the term “hybrid” is used here to qualify the furnace according to the invention, in particular because of the possible use of two different energy sources, especially when the operating mode of the furnace is the so-called hybrid mode, wherein the melting of the vitrifiable mixture is obtained using both electrical and fuel energy.

However, the analogy with the present invention does not go beyond this, since electrical energy (constituting a first source of energy) and fuel energy (constituting a second source of energy) are likely to be used exclusively one or the other to achieve melting, in particular in the other operating modes of the furnace, so that-when used-electrical energy never constitutes a booster in a hybrid furnace 10 according to the invention.

The hybrid furnace 10 according to the invention is particularly intended to supply a float glass unit on a bath of molten metal, generally tin, for the manufacture of flat glass.

As shown by FIGS. 1 and 2, the hybrid furnace 10 according to the first embodiment successively includes from upstream to downstream, along said longitudinal axis A-A′ of the furnace, a melting zone 100, a refining and homogenizing zone 200 (hereinafter referred to as refining zone 200) and a glass cooling zone 300.

Preferably, the hybrid furnace 10 is symmetrical in design with respect to said longitudinal axis A-A′.

In a hybrid furnace 10 according to the invention, said melting zone 100 comprises at least one melting zone 110 using a first energy, e.g. electrical energy, and a melting zone 120 using a second energy, e.g. fuel energy, that is, a second energy different from said first energy.

In the remainder of the description, said at least one melting zone 110 corresponds to an “electric” melting zone, while said melting zone 120 corresponds to a “flame” melting zone, due to the use of at least one fuel.

In a hybrid furnace 10 according to the invention, said at least one electric melting zone 110 and the flame melting zone 120 together forming said furnace melting zone 100 are structurally separate, that is, they constitute separate melting zones, and are functionally independent of one another.

Said at least one electric melting zone 110 is able to deliver a maximum pull rate which is less than or equal to the nominal pull rate of the furnace, that is, between 0% and 100% of the nominal pull rate, preferentially up to 100% in order to be able to obtain said nominal pull rate solely by electric melting.

The flame melting zone 120 is able to deliver a maximum pull rate that is less than or equal to the nominal pull rate of the furnace, that is, between 0 and 100% of the nominal pull rate, preferentially up to 100% in order to be able to obtain said nominal pull rate solely by flame melting, or even between 0 and 50% of the nominal pull rate.

When the flame melting zone 120 is capable of delivering a maximum pull rate which is between 0 and 50% of the nominal pull rate, said nominal pull rate can only be obtained by using flame melting and electric melting together, or only said at least one electric melting zone 110 if said at least one electric melting zone 110 is capable of delivering a maximum pull rate corresponding to 100% of the nominal pull rate.

Preferably, and by comparison with said at least one electric melting zone 110, the hybrid furnace 10 according to the invention comprises a single flame melting zone 120.

According to the invention, said at least one electric melting zone 110 and said flame melting zone 120 are configured to be able to operate independently of one another so as to allow selective use of one and/or the other of said melting zones 110 and 120 and thereby confer energy flexibility to said hybrid furnace 10.

Owing to this design, the hybrid furnace 10 can be operated in several modes, depending on whether only one or two energies are used simultaneously, that is, electricity and/or a fuel, to melt the vitrifiable mixture.

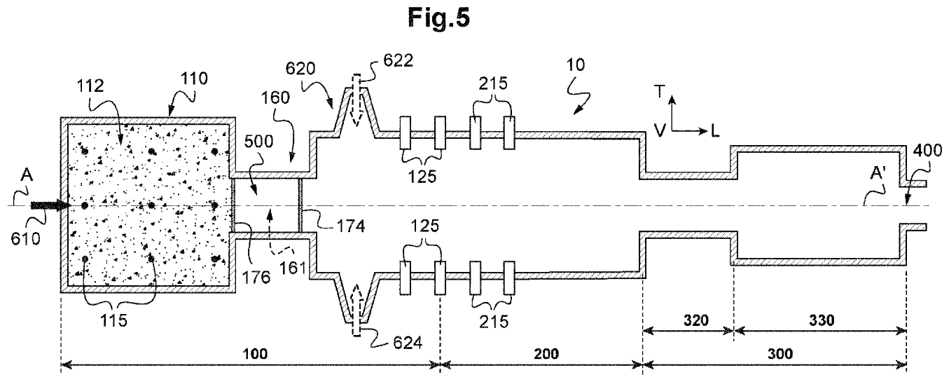

The operating modes of the hybrid furnace 10 will be described in greater detail later, with reference to FIGS. 5 to 7.

The hybrid furnace 10 according to the invention is in fact able to operate in an operating mode which is able to be selectively chosen from:
a first electric melting operating mode wherein molten glass is produced solely by said at least one electric melting zone 110;
a second hybrid operating mode wherein molten glass is produced jointly by said at least one electric melting zone 110 and by said flame melting zone 120;
a third flame melting operating mode wherein molten glass is produced solely by said at least one flame melting zone 120.

Advantageously, the hybrid furnace 10 is also characterized by its multimode operation, enabling the energy or energies used to melt the vitrifiable mixture to be selected according to the operating mode selected, giving the hybrid furnace 10 according to the invention energy flexibility.

We will first describe the melting zone 100 and then the refining zone 200 and the glass cooling zone 300 of a hybrid furnace 10 according to the first embodiment.

The hybrid furnace 10 comprises, on the one hand, at least one electric melting zone 110 which can be supplied with a vitrifiable mixture by at least one first charging device 610 and, on the other hand, the flame melting zone 120 which can be supplied with a vitrifiable mixture by at least one second charging device 620.

The second charging device 620 associated with the flame melting zone 120 is separate from and operationally independent of the first charging device 610 associated with said at least one electric melting zone 110, so that it is possible to use one and/or the other selectively, depending on the furnace operating mode chosen.

In the first embodiment of the invention shown in FIGS. 1 to 7, the hybrid furnace 10 comprises a single cold-top electric melting zone 110 and a hot-top flame melting zone 120.

Preferably, the hybrid furnace 10 comprises a first charging device 610 consisting of a single batch charger for supplying vitrifiable mixture to the electric melting zone 110, said first charging device 610 being represented schematically by an arrow in FIG. 2.

Preferably, the batch charger forming said first charging device 610 is arranged longitudinally, upstream of the electric melting zone 110 as shown in FIG. 2.

Alternatively, said first charging device 610 comprises more than one batch charger, for example two batch chargers, to supply said electric melting zone 110, which is of the cold top type.

Alternatively, the first charging device 610 is not arranged longitudinally but transversely to the furnace axis (A-A′), particularly when the first charging device 610 comprises more than one batch charger.

Advantageously, the first charging device 610 is configured to spread the vitrifiable mixture in a layer covering the entire surface of the molten glass in the electric melting zone 110, preferably substantially uniformly.

By way of example, reference may be made to FR2599734, which describes a charging device or batch charger suitable for spreading the vitrifiable mixture in such a layer covering the surface of a molten glass bath.

Preferably, the second charging device 620 for supplying vitrifiable mixture to said flame melting zone 120 comprises a first batch charger 622 and a second batch charger 624 which are arranged transversely on both sides of said flame melting zone 120, preferably orthogonally to the longitudinal axis (A-A′) of the furnace.

Alternatively, the second charging device 620 comprises a single batch charger for supplying vitrifiable mixture to said flame melting zone 120.

The first batch charger 622 and the second batch charger 624 are each represented schematically by an arrow in FIG. 2.

The state of the art includes numerous examples of screw batch chargers, in particular but not exclusively, which are suitable for supplying vitrifiable mixture to such a flame melting zone 120 of a hybrid furnace 10 according to the invention.

The vitrifiable mixture (also sometimes called “composition”) is generally made up of the raw materials and the cullet (or “crushed glass”), the melting of which produces molten glass.

In a known manner, the cullet is made up of glass debris which, obtained by recycling the glass, are ground and generally cleaned before being subsequently added to the raw materials in order to produce glass again.

Advantageously, the cullet promotes melting, that is to say the transformation by melting of the vitrifiable glass mixture. The use of cullet further saves sand and therefore energy, as cullet has a lower melting point than sand, helping to reduce the carbon footprint of the production process.

In addition, the cullet makes it possible to upgrade the glass used by recycling it (the glass being recyclable ad infinitum), thus reducing the quantities of raw materials needed to manufacture glass, and again helping to reduce the carbon footprint of the glassmaking process.

Advantageously, the vitrifiable mixture contains 10 to 40% cullet, preferentially 30 to 70%, or even 100% cullet.

Preferably, the vitrifiable mixture introduced into the furnace by the first charging device 610 associated with said at least one electric melting zone 110 and the vitrifiable mixture introduced into the furnace by the second charging device 620 associated with said flame melting zone 120 have a similar composition. This is further the case when the electric melting zone 110 and the flame melting zone 120 are used together in the second, so-called hybrid, operating mode.

“Similar” composition of vitrifiable mixture is understood to mean a substantially identical chemical composition that corresponds to that of the glass to be manufactured.

However, the vitrifiable mixture respectively introduced into the electric melting zone 110 and the flame melting zone 120 is not necessarily identical; in particular, it is possible to have a variation in the quantity of cullet in each of the vitrifiable mixtures, or even a selective addition of refining agent(s) in one and not the other.

Advantageously, said at least one electric melting zone 110 and said flame melting zone 120 are arranged in series so that molten glass produced by one of said upstream melting zones is able to flow into the other of said downstream melting zones.

Owing to such an arrangement, the molten glass produced by one of said melting zones mixes with the molten glass produced by the other of said melting zones when said electric and flame melting zones are used together, as in the second hybrid operating mode of the furnace.

In this first embodiment, the hybrid furnace 10 for example longitudinally includes a charging zone 111 wherein the first charging device 610 is arranged (also called a batch charger) which is intended to introduce the vitrifiable mixture into the electric melting zone 110, said charging device 610 being schematically shown by an arrow in FIGS. 1 and 2.

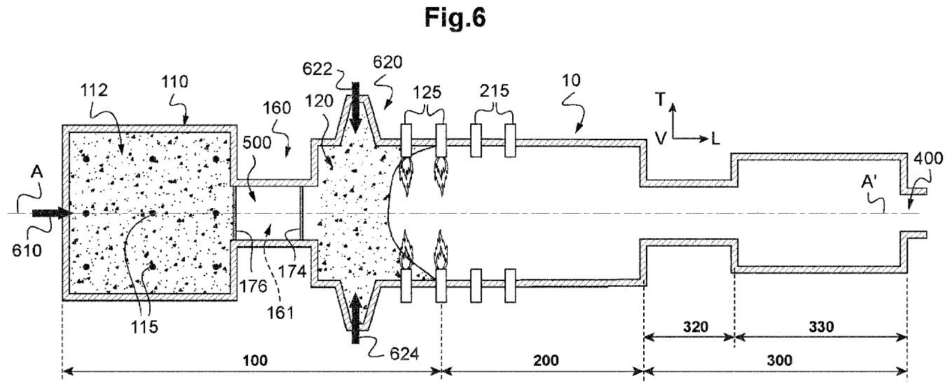

Advantageously, the charging device 610 is configured to deposit the vitrifiable mixture so as to form a layer 112 on the entire surface of a glass bath 113, as shown in particular by FIGS. 5 and 6, on which the layer 112 of vitrifiable mixture has been materialized.

The layer 112 of vitrifiable mixture forms an insulating layer between the glass bath 113 and a top 114 of the electric melting zone 110, which is why such an electric melting zone 110 is referred to as a “cold top”.

Preferably, the glass bath 113 is uniformly covered with such a layer 112 consisting of vitrifiable mixture, for example from 10 to 40 cm thick, and below which the complex chemical reactions take place, which, as described in the preamble of the present application, lead to the molten glass being obtained.

The electric melting zone 110 includes electrodes 115 configured to melt the vitrifiable mixture introduced by the first charging device 610 in order to obtain molten glass, in particular the molten glass bath 113 shown in FIG. 1.

In the electric melting zone 110, the power dissipated around the electrodes 115 generates a high-convection zone comprising in particular very intense rising currents which provide the necessary calories at the boundary between the cast iron and the vitrifiable mixture forming said layer 112.

Furthermore, although permeable to carbon dioxide (CO2), the vitrifiable mixture layer 112 present on the surface of the bath 113 advantageously makes it possible to trap by condensation or by chemical reactions the vapors, which are sometimes toxic depending on the composition, emitted by the molten glass.

Advantageously, the electrodes 115 are arranged on the surface so as to dip into the glass bath 113, through the layer 112 covering the surface of the bath 113 as shown by FIG. 1.

Preferably, the immersed electrodes 115 extend vertically. Alternatively, the immersed electrodes 115 extend obliquely, that is, are inclined so as to have a given angle relative to the vertical orientation.

Alternatively, the electrodes 115 are arranged through a floor 116 of the electric melting zone 110 so as to be totally immersed in the bath 113, the rising electrodes (as opposed to the dip electrodes) extending preferably vertically, alternatively obliquely.

By comparison with electrodes arranged through the floor, the immersed electrodes 115 also allow easier control of their state of wear and lead to a dissipation of the electrical energy which is advantageously closer to the melting interface, from the layer 112 of vitrifiable mixture.

Additionally, the immersed electrodes 115 make it possible, by comparison with rising electrodes, to retain a floor 116 of the electric melting zone 110 which is free of any openings.

Preferably, as shown in FIG. 1, the floor 116 of the electric melting zone 110 is flat. As a variant, the floor 116 comprises at least one variation in depth relative to the surface of the bath 113 of glass, said variation comprising at least one elevation and/or at least one change in level.

Preferably, the fusion electrodes 115 are evenly distributed in the bath 113. Moreover, the number of nine electrodes 115 shown here in FIGS. 1 and 2 is only an illustrative example and is therefore in no way limiting.

Alternatively, the electric melting zone 110 could cumulatively comprise the immersed electrodes and rising electrodes.

According to another alternative arrangement, at least part of the electrodes 115 pass through at least one side wall delimiting said electric melting zone 110, said electrodes 115 then extending horizontally and/or obliquely.

Advantageously, the 115 electrodes are made of molybdenum, this refractory metal withstanding temperatures of 1700 °C, being particularly suitable for melting glass using the Joule effect, as glass only becomes conductive at high temperatures.

Advantageously, the electric melting zone 110 comprises a zone of low convection, called the buffer zone 117, which is situated between the free end of the immersed electrodes 115 and the floor 116.

The electric melting zone 110 of the hybrid furnace 10 is thus configured to present, below the immersed electrodes 115, a depth determined so as to obtain such a low-convection buffer zone 117.

Preferably, the depth between the free end of the immersed electrodes 115 and the floor 116 is greater than 600 mm, preferentially greater than 800 mm.

Such a low-convection buffer zone 117 constitutes another reason to prefer the immersed electrodes 115 relative to rising electrodes passing through the floor 116.

Advantageously, the presence of a low-convection buffer zone 117 participates directly in obtaining a high-quality glass by promoting a longer residence time of the glass in the electric melting zone 110.

As shown in FIGS. 1 and 2, the electric melting zone 110 is located upstream of the flame melting zone 120, with the glass flowing through the hybrid furnace 10 from upstream to downstream, that is, along the longitudinal axis A-A′ of the furnace.

Advantageously, the electric melting zone 110 and the flame melting zone 120 located downstream are connected to one another by a tank neck 160, that is, a zone of reduced width, as shown by FIG. 2.

The molten glass produced by said electric melting zone 110 therefore mixes advantageously with the molten glass produced by the flame melting zone 120 when said electric and flame melting zones are used together, as in the second hybrid operating mode of the furnace.

When the flame melting zone 120 is not used, as in the first electric melting mode, the molten glass produced by the electric melting zone 110 flows through the flame melting zone 120 to the downstream refining zone 200.

Advantageously, such a tank neck 160 ensures cooling of the molten glass as it flows from the electric melting zone 110 to the flame melting zone 120; the greater the length of the tank neck 160, the greater the cooling of the glass.

FIG. 2 non-limitingly shows an example embodiment of the tank neck 160 connecting the electric melting zone 110 to the flame melting zone 120.

According to this example embodiment, the transition from the electric melting zone 110 to the tank neck 160 is achieved by an abrupt narrowing of the width and cross-section of the glass passage, for example here by walls forming an angle of 90° with the longitudinal axis A-A′ of the furnace, and the transition from the tank neck 160 to the flame melting zone 120 is achieved inversely by an abrupt widening of the cross-section of the glass passage, for example here also by walls forming an angle of 90° with the longitudinal axis A-A′ of the furnace.

Alternatively, the angle at the inlet of the tank neck 160 could have a value that is greater than 90° so that the narrowing of the width is less abrupt and more gradual, and likewise the value of the angle at the outlet of the tank neck 160 could be chosen so that the widening is also less abrupt and more gradual along the longitudinal axis A-A′ of the furnace.

Advantageously, the molten glass flowing from upstream to downstream through the tank neck 160 is taken from the lower part of the electric melting zone 110, that is, from the bottom, where the glass is comparatively “colder” than in the zone located between the high-convection electrodes 115.

The tank neck 160 has a floor 165 which is connected to the floor 116 of the electric melting zone 100 of the hybrid furnace 10.

Advantageously, the hybrid furnace 10 includes a “non-return” separation device 170 of the glass configured to prevent molten glass from flowing back from the flame melting zone 120 to the electric melting zone 110.

The separation device 170 is positioned at the tank neck 160, that is, between the electric melting zone 100 and the flame melting zone 120, to ensure the non-return function of the glass.

Advantageously, the separation device 170 is able to prevent the glass from returning to the electric melting zone 110, whether or not the electric melting zone 110 is in use, depending on the operating mode of the hybrid furnace 10.

Several examples of such a “non-return” glass separation device 170 are described below.

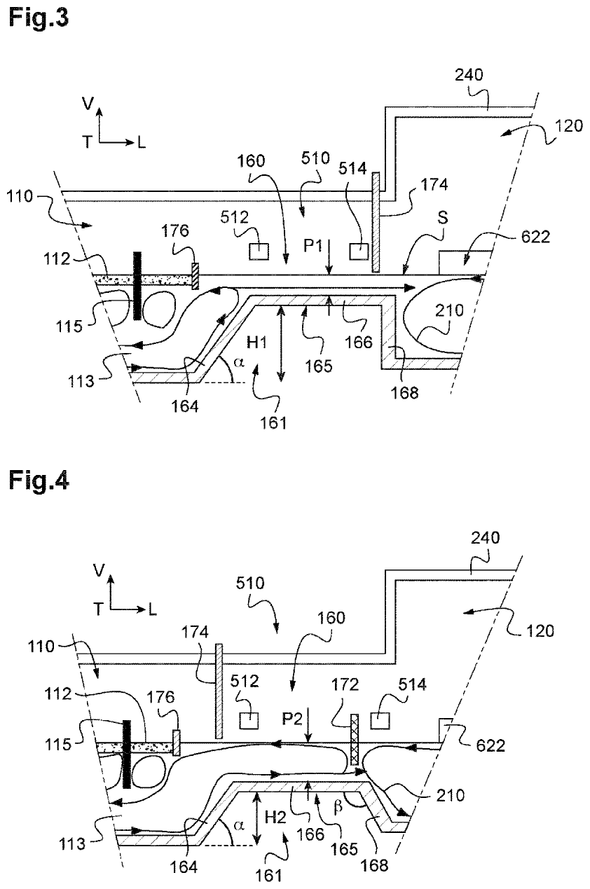

According to a first example shown by FIG. 3, which shows in detail the tank neck 160 of the hybrid furnace 10 according to the first embodiment of FIGS. 1 and 2, the “non-return” glass separation device 170 is formed by at least one elevation 161 of the floor 165 of said tank neck 160.

Preferably, the elevation 161 comprises, successively from upstream to downstream, at least one first ascending section 164, a second plateau section 166 and a third descending section 168.

Advantageously, the elevation 161 extends transversely over the entire width of the tank neck 160.

Of course, such an elevation 161 may have numerous geometric variants as regards its general shape, its dimensions, in particular according to the configuration of each of the different segments 164, 166 and 168 constituting it.

Preferably, the ascending section 164 is inclined by an angle (a) determined so as to form a ramp able to cause the molten glass to rise toward the plateau section 166 of the elevation 161 as shown by FIG. 3.

Preferably, the ascending section 164 is an inclined plane, having for example an acute angle (a) of between 20° and 70°, said angle (a) being denoted as the angle between the ascending section 164 of the elevation 161 and the horizontal, taking the flat floor 116 of the electric melting zone 110 as reference here.

As a variant (not shown), the ascending section 164 is stepped, for example, in staircase fashion with at least one step, or even two or more steps whose height and/or length dimensions may or may not be identical.

Preferably, the plateau section 166 is planar, forming a horizontal plateau.

Advantageously, the plateau section 166 thus extends longitudinally over a given length, preferably here greater than or equal to half the total length of the tank neck 160.

The plateau section 166 determines a maximum height H1 that the elevation 161 has and this determines the section of the passage of the molten glass in the tank neck 160.

The descending section 168 of the elevation 161 extends vertically, connected by a right angle to the downstream end of the flat plateau section 166 that extends horizontally.

Alternatively, and as shown in FIG. 4, which will be described below in a second example of the non-return separation device 170, the descending section 168 is configured to progressively accompany the flow of molten glass from the tank neck 160 toward the flame melting zone 120.

Such a segment 168 is for example formed by an inclined plane, which may or may not be stepped, in particular made in steps like the description given above for the alternative embodiments of the ascending section 164.

Advantageously, the hybrid furnace 10 includes at least one atmospheric separation means 174 capable of separating the atmosphere of the cold-top electric melting zone 110 from the atmosphere of the hot-top flame melting zone 120.

As shown in FIG. 3, the atmospheric separation means 174 is formed, for example, by a partition which, arranged at the tank neck 160, extends vertically from the top and whose lower free end is preferably in contact with the glass surface, or even immersed in the glass.

Advantageously, the hybrid furnace 10 includes immobilizing means 176, also known as “skimmers”, which are able to retain the layer 112 of vitrifiable mixture in the electric melting zone 110 so that said vitrifiable mixture present on the surface of the glass bath 113 does not penetrate into the tank neck 160.

Preferably, the means 176 for immobilizing the layer 112 are structurally separate from the separation means 174, said immobilizing means 176 being able to be adjacent to or remote from said separation means 174 as shown by FIG. 3.

Alternatively, the separation means 174 is not only able to perform the atmospheric separation function between the cold and hot tops, but is also able to perform the function of the immobilizing means 176.

Advantageously, the separation means 174 is then configured to be immersed at its free end in the glass bath 113 in order to retain said layer 112 of vitrifiable mixture in the electric melting zone 110. Preferably, said separation means 174 is positioned at the upstream end of the tank neck 160 so that said layer 112 of vitrifiable mixture present on the surface of the glass bath 113 does not penetrate into the downstream tank neck 160.

According to a second example shown in FIG. 4 and described below by comparison with the first example in FIG. 3, the glass non-return separation device 170 similarly comprises at least one elevation 161 of the floor 165 of the tank neck 160 and a dam 172.

Advantageously, the elevation 161 of the floor 165 of the tank neck 160 is of substantially identical shape to that described above with reference to FIG. 3, namely consisting successively of an ascending section 164, a plateau section 166 and a descending section 168.

However, FIG. 4 shows the previously described variant in which the descending section 168 of the elevation 161 is configured to progressively accompany the flow of molten glass from the tank neck 160 toward the flame melting zone 120. According to this variant, the section 168 is formed, for example, by an inclined plane, which may or may not be stepped.

Advantageously, the dam 172 is arranged above the plateau section 166 of the elevation 161 of the floor 165.

In FIG. 4, the elevation 161 of the floor 165 has a height H2, denoted as before relative to the horizontal at the flat floor 116 of the electric melting zone 110 taken as reference, said height H2 being comparatively less than the height H1 denoted in FIG. 3.

As a result, the depth P2 of glass between the surface S of molten glass and the plateau section 166 of the elevation 161 of the floor 165 is greater than the depth P1 in the example embodiment shown by FIG. 3.

Preferably, the dam 172 associated with the elevation 161 is mounted so that it can be moved vertically to adjust its depth of immersion in the glass bath 113, so that the cross-section of the glass passage between the free end of the dam 172 and the plateau part 166 of the elevation 161 can be varied.

Alternatively, the dam 172 is fixed so that the section of the passage of the glass is then constant, that is, determined by the depth of immersion of said dam 172 in the glass bath 113.

Preferably, the dam 172 is removable, that is to say dismountable, so that said dam 172 is able to be changed, or repaired, in particular due to the wear occurring in contact with the glass, thus facilitating the maintenance of the hybrid furnace 10.

The dam 172 is for example made of non-refractory metal or alloy, said dam then being able to be cooled by a cooling fluid cooling circuit (not shown), in particular a circuit of the water jacket type.

The dam 172 then helps to cool the glass in the tank neck 160 by limiting the flow in the tank neck 160 and owing to the water-jacket cooling fluid cooling circuit, which removes some of the heat (calories) transmitted by the glass to the dam.

Alternatively, the dam 172 is made of refractory material, typically ceramic, for example an electrofused refractory “AZS” (acronym for Alumina-Zircon-Silica) or a refractory metal such as molybdenum.

According to a third example (not shown), the separation device 170 comprises only a dam which, advantageously identical to the dam 172 just described, is intended to be partially immersed in the molten glass bath 113.

Preferably, and by comparison with the arrangement according to the second example shown in FIG. 4, the dam is then positioned at the upstream end of the tank neck 160, at the junction with said electric melting zone 110.

Preferably, the dam extends transversely over the entire width of the tank neck 160 connecting the electric melting zone 110 to the flame melting zone 120.

Advantageously, as described above, the dam is mounted so that it can be moved vertically to adjust its depth of immersion in the glass bath 113, or alternatively occupies a fixed position determining a given glass passage cross-section.

Advantageously, the dam arranged upstream of the tank neck 160 is capable of immobilizing the layer 112 of vitrifiable mixture covering the glass bath 113 in the electric melting zone 110, thus fulfilling the function of the immobilizing means 176 previously described with reference to FIG. 3 to the benefit of eliminating such immobilizing means 176.

As previously described in FIG. 4, the dam is advantageously removable, and depending in particular on the type of material used for its construction, is cooled by a cooling fluid cooling circuit.

Advantageously, and according to the examples described above, the glass non-return separation device 170 comprises a dam 172 capable of being partially immersed in the molten glass and/or at least one elevation 161 of the floor 165 of the tank neck 160.

Advantageously, the hybrid furnace 10 comprises means 500 for cooling the glass capable of selectively cooling the glass in the tank neck 160.

In addition to the cooling of the glass during its flow through the tank neck 160 connecting the electric melting zone 110 to the flame melting zone 120 located downstream, such cooling means 500 make it possible to further increase the cooling of the glass and especially to vary this cooling by virtue of which a regulation of the temperature of the glass is obtained.

Preferably, the means 500 for cooling the glass in the tank neck 160 comprise at least one air-circulation cooling device 510.

The following is an example embodiment of a cooling device 510 as more particularly shown schematically in FIGS. 3 and 4.

Such an air-cooling device 510 for the glass comprises for example at least intake means 512 for introducing cooling air into the atmosphere of said tank neck 160 of the hybrid furnace 10.

Preferably, the device 510 for cooling the glass comprises discharge means 514 arranged in the tank neck 160 to discharge the hot air and ensure its renewal by fresh cooling air.

Alternatively, the discharge means are formed by extraction means (not shown) which, located downstream of the tank neck 160, are intended to extract fumes. Advantageously, the hot air is then discharged with the fumes by said extraction means without the hybrid furnace 10 having to be equipped with additional means.

The air intake means 512 and the air discharge means 514 of the glass cooling device 510 are for example formed by one or more openings that open into the breast walls supporting the top of the tank neck 160.

The intake means 512 and the air discharge means 514 are for example arranged transversely on either side of the tank neck 160, alternatively on only one of the sides of the tank neck 160.

The air intake means 512 and air discharge means 514 of the glass cooling device 510 may be arranged upstream of the atmospheric separation means 174, as shown in FIG. 3, or even downstream, as shown in FIG. 4.

Advantageously, the temperature of the cooling air introduced into the tank neck 160 is lower than the temperature of the hot air located inside the tank neck 160, the cooling air circulated forming a cooling fluid.

Preferably, the cooling air used is atmospheric air taken outside the hybrid furnace 10, or even outside the enclosure of the building wherein said hybrid furnace 10 is installed.

Advantageously, the temperature of the atmospheric air used is controlled so that it can be regulated; for example, the air can be pre-cooled or reheated before being introduced to control its temperature, or even the hygrometry.

Glass cooling is mainly achieved by convection, with the cooling air introduced heating up as it comes into contact with the surface of the glass, before being removed along with the heat (calories) transmitted by the glass.

Advantageously, the circulation of air is able to be controlled by means of air blowing means (not shown) such as fans which, associated with said intake and/or discharge means, are able to be controlled selectively to vary the flow rate of air circulating.

According to another embodiment, the means 500 for cooling the glass are immersed in the glass flowing from upstream to downstream through said tank neck 160 in order to allow the cooling thereof.

Such cooling means are for example formed by vertical studs immersed in the glass which are cooled by a cooling circuit with heat transfer fluid in order to discharge the heat transmitted to said studs by the molten glass.

According to yet another embodiment, the cooling means 500 include a heat exchanger-type cooling device further comprising metallic cooling means which are arranged in the atmosphere around the tank neck 160, that is, above the glass surface, and through which a cooling fluid, typically water, flows in order to cool the air and thus the molten glass.

Of course, the cooling means 500 associated with the tank neck 160 such as those according to the various examples that have just been described are able to be implemented alone or in combination.

Advantageously, the means 500 for cooling the glass associated with the tank neck 160 make it possible to selectively control the temperature of the glass, a temperature which is likely to vary, in particular when the pull rate varies, as an increase in the pull rate causes an increase in the temperature of the glass.

Preferably, the glass cooling means 500 associated with the tank neck 160 are used when the electric melting zone 110 is also in use, that is, in the first electric melting operating mode or the second hybrid operating mode of the furnace.

As previously described, said electric melting zone 100 is connected by the tank neck 160 to the flame melting zone 120 of the hybrid furnace 10.

The flame melting zone 120 comprises at least “overhead” burners 125 for melting the vitrifiable mixture that can be introduced by the second charging device 620, said overhead burners 125 being arranged above the surface S of the molten glass.

In a variant which is not shown, the hybrid furnace 10 includes modulation means (not shown) such as electric boosting and/or boilers which are arranged in said flame melting zone 120.

The flame melting zone 120 for example includes four overhead burners, which are shown schematically in FIGS. 1 and 2.

The overhead burners 125 are arranged transversely, and as a result are often referred to as “transverse burners”, and are arranged, for example, on both sides of the flame melting zone 120, here shown facing one another, alternatively preferentially offset from one another so as not to face one another.

The hybrid furnace 10 has at least one other burner 215 located downstream of the overhead burners 125, whose main function is not to melt the vitrifiable mixture but to conduct the glass.

Preferably, the hybrid furnace 10 has four overhead burners 215, which, like the burners 125, are distributed transversely on both sides of the refining zone 200.

The melting of the vitrifiable mixture in the flame melting zone 120 and the selective heating of the glass in the refining zone 200 are achieved by the flames delivered respectively by the overhead burners 125 and the burners 215 supplied with fuel for this purpose, which flames develop by combustion above the surface S of the glass.

This is why the burners 125 or 215 are referred to as “overhead” burners, as opposed to “immersed” burners, which are based on a completely different technology.

The delimitation between the flame-melting zone 120 and the refining zone 200 as shown in the figures is indicative and by no means restrictive. Indeed, the delimitation is not a fixed line but a variable one, depending in particular on the pull rate and the operating mode of the furnace, said delimitation corresponding by convention to the line of separation between the presence and absence of vitrifiable mixture on the surface of the glass bath.

Advantageously, the flame-melting zone 120 extends, along the longitudinal axis (A-A′) of the furnace, over a length (L) which further determines the maximum pull rate that can be produced by said flame melting zone 120.

After the melting zone 100, the refining zone 200 and the cooling zone 300 of the hybrid furnace 10 according to the first embodiment shown in FIGS. 1 and 2 will now be described.

The refining zone 200 of the hybrid furnace 10 is configured to eliminate the bubbles (or gaseous defects) present in the molten glass coming from the electric melting zone 100 and/or the flame melting zone 120 in order to obtain a glass which is of high quality, and this advantageously makes it possible to supply a float glass unit.

To do this, the refining zone 200 is configured to include a first convection loop 210, called the upstream recirculation loop, and a second convection loop 220, called the downstream recirculation loop.

Preferably, the first convection loop 210, called the upstream recirculation loop, is longitudinally shorter than the second convection loop 220 as shown in FIG. 1.

Advantageously, the convection currents in the glass corresponding to said loops 210, 220 stir the glass, eliminating bubbles and increasing the residence time of the glass in the refining zone 200, thus helping to obtain high-quality glass.

Advantageously, the flame melting zone 120 of the hybrid furnace 10 is traversed by said first convection loop 210 of the refining zone 200.

In the second hybrid operating mode, the first convection loop 210 therefore also participates in mixing the molten glass delivered by the electric melting zone 110 and the flame melting zone 120, which are used together.

The first convection loop 210 and the second convection loop 220 are separated by an inversion zone 230 of the loops 210, 220 which is determined by a hot spot (also called “source point”) corresponding to the hottest point of the glass in the refining zone 200, generally at a temperature of greater than 1500 °C.

Advantageously, the burners 215 are arranged under a top 240 of the refining zone 200 to obtain said hot spot determining the inversion zone 230 of said loops 210, 220.

In the refining zone 200 of the furnace, part of the thermal energy released by the combustion is transmitted directly to the glass by radiation and convection, another part is transmitted by the top 240 which returns it to the glass by radiation, and which in particular for this reason is called “hot top”.

Advantageously, the hybrid furnace 10 features a ridge 260 in the loop inversion zone 230. Preferably, the ridge 260 extends vertically from a floor 250 of the refining zone 200.

As shown in FIG. 1, the ridge 260 comprises a plateau part that, immersed below the surface S of the glass, determines the passage of the glass from the first convection loop 210, called the upstream recirculation loop, toward the second convection loop 220, called the downstream recirculation loop.

Preferably, the hybrid furnace 10 comprises modulation means (not shown) such as electric boosting and/or boilers which, arranged in the flame melting zone 120 and/or the refining zone 200, are able to make it possible to modulate the convection of said loops 210, 220 in order to facilitate the glassmaking process.

Advantageously, the modulation means therefore comprise electric boosting, that is, means of additional electrical heating comprising electrodes and/or boilers, that is, a system for injecting at least one gas, such as air or nitrogen, at the floor, the bubbles of which then create an upward movement of the glass.

Preferably, the hybrid furnace 10 comprises at least one variation 270 of the depth, relative to the surface S of the glass, of the floor 250 of the refining zone 200.

The depth variation 270 is located in the part comprising the first convection loop 210 and/or in the part comprising the second convection loop 220.

Advantageously, the variation 270 of the depth of glass is for example constituted by at least one elevation of the floor 250 shown by FIG. 1. Alternatively, the variation 270 of the depth is constituted by at least one difference in level of the floor 250.

The elevation of the floor 250 forming the depth variation 270, i.e. here a reduction of the depth, is for example constituted by at least one step 272, or even two steps.

The depth variation 270 can be more or less gradual, for example via a straight section 274 in the case of that located upstream of the ridge 260, or alternatively via an inclined section 276 in the case of a step 322 located downstream of the ridge 260, at the junction of the refining zone 200 and the glass cooling zone 300.

Preferably, the cooling zone 300 also includes a variation 370 in depth which is formed by an elevation including, for example, the step 322 to which the inclined portion 276 leads from the floor 250 and another step 332, downstream of said step 322. The step 322 also connects gradually to the other step 332 via an inclined portion 376.

Alternatively, the respectively straight and inclined portions that have just been described with reference to FIG. 1 could be reversed between the steps 272 on the one hand and the steps 322, 332 on the other hand, or else only of one and the same type, that is to say either straight or inclined.

As shown in FIG. 1 and as has just been described with the successive steps 322 and 332, the cooling zone 300 comprises a floor 350 which is configured so that the depth relative to the glass surface S gradually decreases from upstream to downstream, from the ridge 260.

The glass cooling zone 300 of the hybrid furnace 10 is passed through by the second convection loop 220, known as the downstream recirculation loop.

The cooling zone 300 is formed by a conditioning tank 310 which communicates with at least one flow channel 400 which is intended, for example, to supply high-quality glass to a forming zone located downstream and preferentially consisting of a float glass unit on a molten metal bath (not shown).

Advantageously, the conditioning tank 310 of the cooling zone 300 comprises, from upstream to downstream, another tank neck 320, referred to as second tank neck, then a working end 330.

Advantageously, the atmosphere of the refining zone 200 and the colder atmosphere of the cooling zone 300 are separated from one another by a heat screen 360 extending vertically from a top 340 to the vicinity of the surface S of the glass, preferentially without tempering in the glass.

Advantageously, in any vertical plane transverse to the longitudinal axis A-A′ of the hybrid furnace 10, there exists in the conditioning tank 310, points in the glass having a longitudinal velocity component running from downstream to upstream.

After the conditioning tank 310, no return current takes place in a flow channel 400 intended to supply glass to the forming zone, in other words the flow of the glass in the channel 400 is a “piston” flow.

Advantageously, the hybrid furnace 10 according to the invention is capable of delivering a high-quality glass having less than 0.1 bubbles per liter, preferentially less than 0.05 bubbles per liter, such a high-quality glass suitable most particularly for supplying a float glass unit intended to produce a flat glass.

Advantageously, the hybrid furnace 10 is capable of supplying a float glass unit on a molten metal bath with a nominal pull rate greater than or equal to 400 tons per day, preferentially between 600 and 900 tons per day, or even 1000 tons per day or more, with a high-quality glass having less than 0.1 bubble per liter.

Preferably, the hybrid furnace 10 for manufacturing glass according to the invention supplies, via said flow channel 400, a float glass unit on a bath of molten metal, for example tin, intended for the manufacture of flat glass.

According to the invention and as previously described, the hybrid furnace 10 according to the first embodiment is further characterized in that it comprises an electric melting zone 110 and a flame melting zone 120 which, being able to operate independently of one another, give said hybrid furnace 10 energy flexibility.

In a hybrid furnace 10 according to the invention, energy flexibility refers to the energy used for the melting stage of the vitrifiable mixture, which is the most energy-intensive stage of the glassmaking process.

Advantageously, the electrodes 115 constitute the heating means of the electric melting zone 110 for melting the vitrifiable mixture, while the burners 125 preferentially constitute the only heating means of the flame melting zone 120. Alternatively, said burners 125 constitute the main heating means when using boosting electrical heating means including immersed electrodes.

Owing to this design of the melting zone 100 of the hybrid furnace 10, it is possible to choose one of the three operating modes mentioned above, that is, the first electric melting operating mode, the second so-called hybrid operating mode and the third flame melting operating mode.

Advantageously, the electric melting zone 110 is able to deliver a maximum pull rate which is less than or equal to the nominal pull rate of the furnace, that is, between 0% and 100% of the nominal pull rate.

Preferably, the electric melting zone 110 is able to deliver a maximum pull rate of up to 100%, so that said nominal pull rate can be obtained solely by electric melting, typically in the first operating mode.

Advantageously, the flame melting zone 120 is able to deliver a maximum pull rate that is less than or equal to the nominal pull rate of the furnace, that is, between 0 and 100% of the nominal pull rate, preferentially up to 100% in order to be able to obtain said nominal pull rate solely by flame melting, typically in the third operating mode.

Preferably, the flame melting zone 120 is able to deliver a maximum pull rate that is between 0 and 50% of the nominal pull rate. As a result, in order to achieve the nominal pull rate, the electric melting zone 110 must be used in conjunction with the flame melting zone 120 to reach 100%, as will be the case in the second hybrid operating mode.

In a hybrid furnace 10 according to the invention, the energy used to melt the vitrifiable mixture will therefore depend on the selected operating mode, which can be determined in particular based on the desired pull rate in relation to the nominal pull rate of the hybrid furnace 10.

Preferably, the vitrifiable mixture is melted in whole or in part in the electric melting zone 110 of the hybrid furnace 10, so that melting is thus achieved either solely with electric energy according to the first electric melting operating mode, or mainly with electric energy in combination with a fuel according to the second hybrid operating mode.

Advantageously, electricity represents more than 60%, or even 80% and even more, of the total energy used in the hybrid furnace 10 for the glassmaking process, and particularly for melting the vitrifiable mixture, the most energy-intensive stage of the process.

In fact, as explained in the preamble, there is an ongoing effort to reduce the carbon footprint of the glassmaking process.

Thus, when the fuel energy is a fossil fuel such as natural gas, and by comparison the electrical energy is entirely or partially “green” electricity obtained from renewable and decarbonized energies, then electricity is generally preferred for at least this reason.

However, although electricity may be the preferred energy source for melting, the hybrid furnace 10 also offers a third mode of operation with flame melting using a fuel, which guarantees that glass can always be made, even in the event of a power supply problem, for example, avoiding any forced shutdown of the hybrid furnace 10.

As is well known, the hybrid furnace 10 can include regenerators made of refractory materials that operate (for example, in pairs and in inversion) or metal exchangers that respectively use the heat contained in the fumes from manufacturing to preheat the fluids (fuel and oxidant) supplying the burners 125 and/or 215 and thus improve combustion.

The overhead burners 125 (and the burners 215) produce a flame by combustion which can be obtained by combining different types of fuel and oxidant but the choice of which also has direct consequences in the carbon footprint of glassmaking, or direct and indirect emissions of greenhouse gases which are linked to the manufacture of the product, in particular carbon dioxide emissions (CO₂).

However, while the fuel most often used in burners 125 is gas, it is possible to further improve the carbon footprint of the glassmaking process by using a “green-fuel”, in particular “biogas”, preferentially “bio-methane” (CH₄).

“Biogas” is a gas composed essentially of methane and carbon dioxide, produced by methanization, the fermentation of organic matter in the absence of oxygen.

Hydrogen (H₂) is even more preferentially used as a fuel because, compared with biogas, it is advantageously carbon-free, and without carbon there are no carbon dioxide (CO₂) emissions.

For the combustion by the burners 125 and 215, the oxygen present in the air is generally used as oxidizer, which air can, however, be enriched with oxygen in order to obtain oxygen-enriched air, or even virtually pure oxygen is used in the particular case of oxy-fuel combustion.

As mentioned above, the fluids (fuel and oxidant) supplying the burners 125, 215 may be preheated to improve combustion, in particular by means of metal exchangers using the heat contained in the fumes from the manufacturing process.

Advantageously, the energy flexibility obtained with a hybrid furnace 10 according to the invention is therefore total, making it possible to choose both the energy or energies used for melting, and the proportion wherein they are used.

Advantageously, the selection of one of the three operating modes of the hybrid furnace 10 is, for example, based on at least one selection parameter comprising:
an economic criterion which is based on the respective cost of the electrical energy and the fuel further used to melt the vitrifiable mixture;
an ecological criterion which is based on the carbon footprint (CO2) respectively associated with the electrical energy and said fuel, and
at least one technical criterion that is based on the pull rate to be produced in relation to the quantity of molten glass that can be obtained by means of said at least one electric melting zone 110 and/or flame melting zone 120 and/or based on the composition of the glass to be produced, or even of the cullet content of the vitrifiable mixture.

Advantageously, the hybrid furnace 10 is controllable by an associated control unit (UC), in particular controllable by the control unit (UC) to select, according to at least one of the aforementioned selection parameters, one of the operating modes respectively shown in FIGS. 5 to 7, which will be described below.

FIG. 5 shows the hybrid furnace 10 according to the first embodiment in the first electric melting operating mode.

In this electric melting version, the glass is produced solely in the electric melting zone 110 by means of the electrodes 115, said zone 110 being supplied with a vitrifiable mixture by the first charging device 610.

The second charging device 620 associated with the flame melting zone 120 is at a standstill, which is why the arrow showing it schematically has been shown as a dotted line.

As can be seen in FIG. 5, the vitrifiable mixture is advantageously distributed uniformly over the surface of the glass bath 113 in a layer 112 which is retained by the immobilizing means 176 described above so as not to penetrate the tank neck 160.

In this first electric melting operating mode, in the absence of flame melting by means of overhead burners 125, the second charging device 620 is at a standstill, so no vitrifiable mixture is delivered to said flame melting zone 120.

The molten glass produced in the electric melting zone 110 flows longitudinally from upstream to downstream, the separation device 170 arranged at the tank neck 160 advantageously preventing any return of the glass to the electric melting zone 110.

In this way, molten glass flows from the electric melting zone 110 through the tank neck 160 to the flame melting zone 120, then to the refining zone 200, where the glass is refined by circulating along the first convection loop 210.

In the first electric melting operating mode, if no fuel is used in the burners 125 to melt the vitrifiable mixture, the glass surface is selectively heated by flames from at least one of the burners 215 in said refining zone 200 to obtain the hot spot, so as to perfect the refining and homogenization of the glass by eliminating the bubbles (or gaseous defects) present in the molten glass.

Advantageously, by adjusting the power of part of said at least one burner 215 located downstream in the vicinity of the ridge 260, it is possible to adjust the longitudinal distribution of the temperatures and therefore the position of the hot spot which is an important parameter for furnace operation.

The glass then crosses said ridge 260 at the loop inversion zone 230, passing from the first convection loop 210 to the second convection loop 220, and travels through the cooling zone 300 along said second convection loop 220.

In the cooling zone 300, the glass circulating along said second convection loop 220 passes through the second tank neck 320 and then the working end 330 before finally exiting the hybrid furnace 10 through the glass flow channel 400.

FIG. 6 shows the hybrid furnace 10 according to the first embodiment in the second hybrid operating mode, which will be described below by comparison with FIG. 5.

In this second hybrid furnace operating mode, the electric melting zone 110 and the flame melting zone 120 are used simultaneously to obtain the molten glass, and as a result two different energy sources, electricity and fuel, respectively.

However, the proportion of electricity and fuel is advantageously freely parameterizable, depending in particular on the aforementioned selection criteria and within the limit of the maximum pull rate that each melting zone 110, 120 is likely to produce in relation to the nominal pull rate of the hybrid furnace 10.

In this way, the electricity used to power the electrodes 115 and the fuel to power the overhead burners 125 can be used in equal proportions, either in a 50/50 ratio, or in any other ratio.

Preferably, electricity predominates over fuel, for example with a 60/40 ratio, or even an 80/20 ratio (that is, 80% electricity and 20% fuel).

Alternatively, fuel could also be preferred to electricity, particularly for ecological reasons based on their respective carbon footprints (CO₂); this would be the case, for example, of a fuel advantageously formed by hydrogen (H₂), or even a biogas, whereas the electricity would not have been produced from renewable and decarbonized energies but from a fossil fuel such as coal.

As shown in FIG. 6, vitrifiable mixture is present in the electric melting zone 110 and the flame melting zone 120, each supplied by the first 610 and second 620 charging devices, respectively, comprising the first 622 and second 624 batch chargers, which are arranged transversely in this first embodiment.

The molten glass produced by the electric melting zone 110 flows through the tank neck 160 as described above for FIG. 5, but this molten glass then mixes in the flame melting zone 120 with the molten glass produced by the latter; the molten glass resulting from this mixture then circulates along the first convection loop 210 to the refining zone 200.

Owing to the series arrangement of electric melting zone 110 and flame melting zone 120, the molten glass produced by said zone 110 flows into said downstream flame melting zone 120 for mixing.

Advantageously, the tank neck 160 comprising the separation device 170, or even the cooling means 500 such as the air circulation cooling device 510, can also be used to control this flow, in particular the temperature of the glass.

The path of the molten glass from the refining zone 200 through the cooling zone 300 to the channel 400 is identical to that previously described with reference to FIG. 5, so that it can be advantageously referred to without needing to be repeated here.

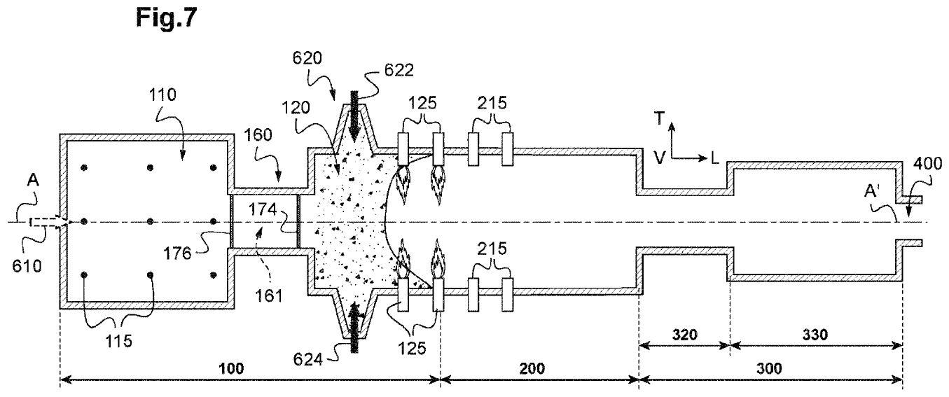

FIG. 7 shows the hybrid furnace 10 according to the first embodiment in the third flame melting operating mode, which will be described below by comparison with that of FIG. 6.

In this third operating mode, molten glass is produced solely by the flame melting zone 120, so the unused electric melting zone 110 is not supplied with vitrifiable mixture by the first charging device 610, which is at a standstill, as shown by the dotted arrow.

For this reason, in FIG. 7, no layer 112 of vitrifiable mixture is visible in said electric melting zone 110 compared with FIGS. 5 and 6 described above.

The vitrifiable mixture is introduced transversely on both sides into said flame-melting zone 120 respectively by the first batch charger 622 and by the second batch charger 624 forming said second charging device 620 of the hybrid furnace 10.

The melting of said vitrifiable mixture is obtained owing to the flames produced by the burners 125 during the combustion of the fuel advantageously constituted by hydrogen (H2), or even a biogas such as bio-methane (CH₄).

The molten glass obtained circulates along the first convection loop 210 extending longitudinally between said flame melting zone 120 and the refining zone 200.

Advantageously, the molten glass remains in the flame melting zone 120 without entering the tank neck 160 located upstream, that is, in the direction of the electric melting zone 110, owing in particular to the glass non-return separation device 170.

As shown in FIGS. 3 and 4 and described above, the glass non-return separation device 170 advantageously comprises a dam 172 capable of being partially immersed in the molten glass and/or at least one elevation 161 of the floor 165 of the tank neck 160.

The absence of electric melting in this third flame operating mode does not necessarily mean a complete shutdown of the electric melting zone 110.

Preferably, the electrodes 115 remain supplied with electricity to maintain a temperature above the devitrification temperature in the electric melting zone 110. However, if no vitrifiable material is introduced by the first charging device 610, no molten glass is produced.

Advantageously, maintaining such a temperature in the electric melting zone 110 thus corresponds to a standby mode enabling a faster changeover to either the first electric melting operating mode or the second hybrid operating mode.

Alternatively, if operation in said third mode is planned for a long period of time, it may be possible to shut down the electric melting zone 110. Preferably, a means such as a dam 172 is then arranged in the tank neck 160 to hold the glass in the flame melting zone 120.

As previously for FIG. 6, the path of the molten glass from the refining zone 200 through the cooling zone 300 to the channel 400 is identical to that previously described with reference to FIG. 5, so that it can be advantageously referred to.

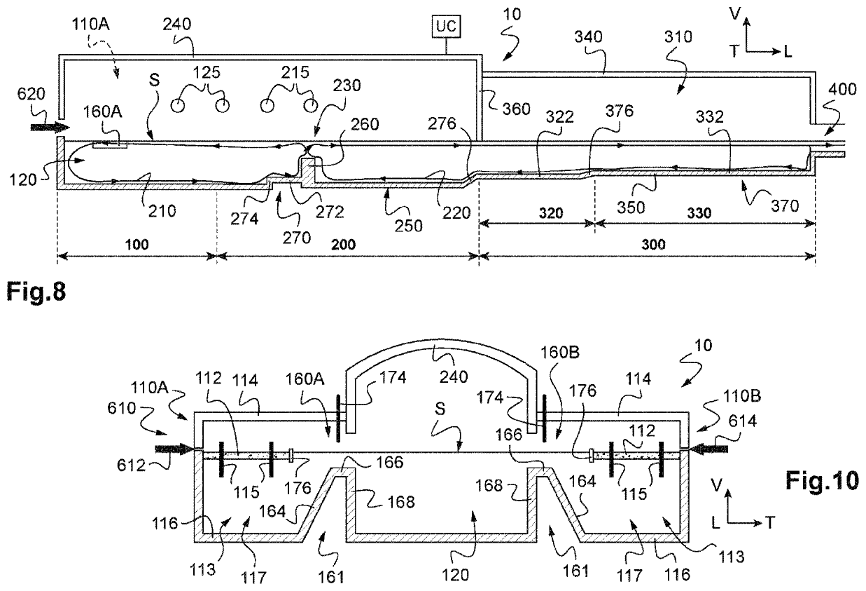

The following is a description, by comparison with the first embodiment, of a second embodiment of the hybrid furnace 10 according to the invention as shown by FIGS. 8 to 12.

In this second embodiment, the hybrid furnace 10 comprises a melting zone 100 with at least a first electric melting zone 110A and a second electric melting zone 110B.

In this second embodiment, the hybrid furnace 10 preferentially comprises two electric melting zones, 110A and 110B respectively; alternatively, the hybrid furnace 10 could comprise more than two electric melting zones.

Compared with the first embodiment, wherein the hybrid furnace 10 has a single electric melting zone 110, the fact of having at least two or more electric melting zones in this second mode further offers various advantages.

Depending on the pull rate to be delivered in electric fusion, it is advantageously possible to choose to use only one of the electric melting zones 110A and 110B.

In addition, it is also possible, for example, to use only one of the melting zones when a maintenance or other operation must be carried out in the other of said electric melting zones.

Advantageously, said electric melting zones 110A and 110B are designed to be used together.

Advantageously, the two electric melting zones 110A and 110B are of similar design to the electric melting zone 110 described above for the first embodiment and will therefore not be described in detail.

The two electric melting zones 110A and 110B of the hybrid furnace 10 further comprise electrodes 115, of which there are for example six here in each zone as shown in FIG. 9.

In this second embodiment, said zones 110A and 110B each have a smaller surface area than that of said melting zone 110 of the first embodiment.

Preferably, the electrodes 115 are arranged on the surface so as to be immersed into the vitrifiable mixture, the immersed electrodes 115 extending vertically.

Preferably, said electric melting zones 110A and 110B are capable of delivering a pull rate greater than or equal to that of the electric melting zone 110 of the first embodiment.

Advantageously, said electric melting zones 110A and 110B are able to deliver a maximum pull rate which is less than or equal to the nominal pull rate of the furnace, that is, between 0% and 100% of the nominal pull rate, preferentially up to 100% in order to be able to obtain said nominal pull rate solely by electric melting.

As shown in FIG. 9, the first electric melting zone 110A and the second electric melting zone 110B are arranged transversely on both sides of the flame melting zone 120.

Preferably, the first electric melting zone 110A and the second electric melting zone 110B are arranged orthogonally to the longitudinal axis (A-A′) of the furnace.

Advantageously, the first charging device 610 comprises a first batch charger 612 for supplying vitrifiable mixture to the first electric melting zone 110A and a second batch charger 614 for supplying vitrifiable mixture to the second electric melting zone 110B.

The first batch charger 612 and the second batch charger 614 are shown schematically by arrows in FIGS. 9 to 12. The first batch charger 612 and the second batch charger 614 are arranged transversely to supply vitrifiable mixture to the first electric melting zone 110A and the second electric melting zone 110B, respectively.

Advantageously, the first batch charger 612 and the second batch charger 614 forming the first charging device 610 are configured to spread the vitrifiable mixture in a uniform layer 112 over the surface of the molten glass bath 113 in each of said first and second electric melting zones 110A and 110B.

Advantageously, said electric melting zones 110A and 110B and said flame melting zone 120 are arranged in series so that the molten glass produced by each of said melting zones 110A and 110B flows into the flame melting zone 120 located downstream.

The first electric melting zone 110A and the second electric melting zone 110B are respectively connected to the flame melting zone 120 by a first tank neck 160A and by a second tank neck 160B.

Advantageously, the first tank neck 160A and the second tank neck 160B are identical to the tank neck 160 according to the first embodiment and will therefore not be described in further detail.

Advantageously, the hybrid furnace 10 includes a glass non-return separation device 170 in each of said tank necks 160A and 160B.

Preferably, each separation device 170 comprises at least one elevation 161 of the floor 165 as described with reference to FIG. 3 of the first embodiment.

Advantageously, the hybrid furnace 10 also comprises, in each of said first tank neck 160A and second tank neck 160B, atmospheric separation means 174 and immobilizing means 176 suitable for retaining the vitrifiable mixture.

Advantageously, the hybrid furnace 10 comprises cooling means 500, preferably an air cooling device 510 which, identical to that described above for the first embodiment, is not shown schematically in FIGS. 8 to 12.

Preferably, said second charging device 620 for supplying vitrifiable mixture to said flame melting zone 120 comprises at least one screw batch charger.

As shown in FIG. 9, the second charging device 620 is arranged longitudinally opposite the furnace, that is, along the longitudinal axis (A-A′) of the furnace, upstream of the flame melting zone 120.

With the exception of the vitrifiable mixture charging device 620, the hybrid furnace 10 according to the second embodiment comprises a flame melting zone 120 which, comprising overhead burners 125, is identical to that described above for the first embodiment, to the description of which reference will therefore be made.

The hybrid furnace 10 comprises a refining zone 200 and a cooling zone 300 which are respectively identical to those of the first embodiment, to the description of which reference is advantageously made, the same reference signs having been used for this purpose in FIGS. 8 to 12 showing the second embodiment.

In this second embodiment, shown in FIGS. 8 to 12, the first electric melting zone 110A and the second electric melting zone 110B are arranged transversely on both sides of the flame melting zone 120.

Alternatively, the first electric melting zone 110A and the second electric melting zone 110B are arranged longitudinally upstream of the flame melting zone 120, one next to the other, with a tank neck 160A, 160B extending parallel to the longitudinal axis (A-A′) of the furnace or obliquely, that is, at a given acute angle to said longitudinal axis (A-A′).

In such an embodiment, the second charging device 620 is arranged transversely, preferably orthogonally to the longitudinal axis (A-A′), relative to the flame melting zone 120.

Preferably, the second charging device 620 comprises a first batch charger 622 and a second batch charger 624 as in the first embodiment shown in FIG. 2, that is, arranged transversely on both sides of the flame melting zone 120 to be supplied with vitrifiable mixture, orthogonally to the longitudinal axis (A-A′) of the furnace.

Advantageously, the hybrid furnace 10 according to the second embodiment is able to operate in several operating modes, which also provides energy flexibility.

As in the first embodiment, the hybrid furnace 10 features a first electric melting mode, a second hybrid mode and a third flame melting mode, respectively.

Advantageously, the hybrid furnace 10 can be controlled by a control unit (UC), shown schematically in FIG. 8, in order to select one of said operating modes according to at least one of the selection parameters described above, namely an economic criterion, an ecological criterion and at least one technical criterion.

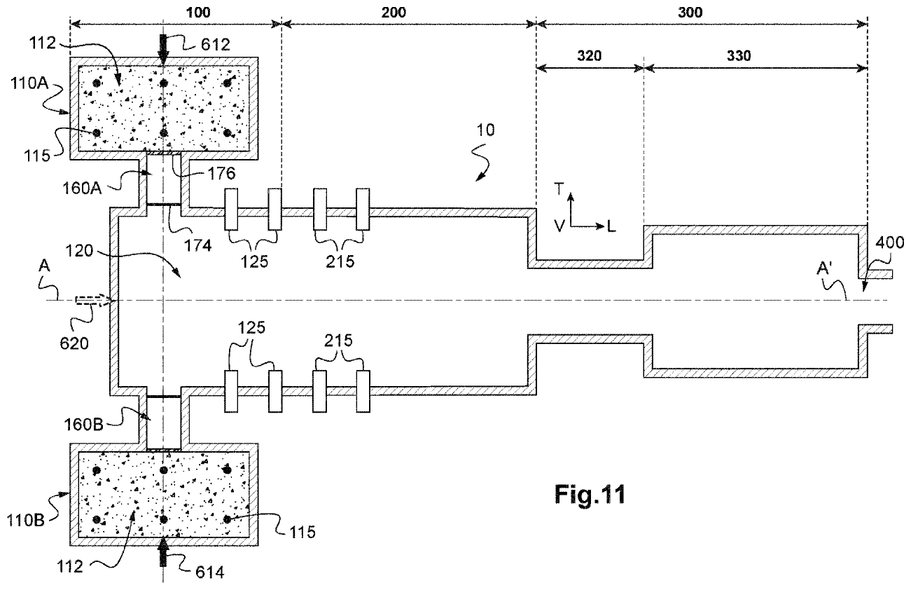

FIG. 11 shows the hybrid furnace 10 according to the second embodiment of the invention in the second electric melting mode of operation, wherein molten glass is produced solely by electric melting, that is, with electricity as the energy source, without using the flame melting zone 120.

As a result, both the overhead burners 125 and the second charging device 620 associated with the flame melting zone 120 are at a standstill, as shown by the absence of flames and the use of the dotted line for the arrow, respectively.

As shown in FIG. 11, the first electric melting zone 110A and the second electric melting zone 110B are covered with a layer 112 of vitrifiable mixture, preferably uniformly, which layer 112 is retained by immobilizing means 176 extending longitudinally upstream of the first tank neck 160A and the second tank neck 160B.

In this way, the first electric melting zone 110A and the second electric melting zone 10B are only supplied with vitrifiable mixture by the first furnace 612 and the second furnace 614, respectively.

The molten glass respectively produced by the first electric melting zone 110A and the second electric melting zone 110B will flow transversely through the first tank neck 160A and the second tank neck 160B to the flame melting zone 120 through which the first convection loop 210 of the refining zone 200 passes.

The molten glass then passes through the refining zone 200 and the cooling zone 300 to the flow channel 400.

As the first mode of operation with electric melting in a hybrid furnace 10 according to this second embodiment is otherwise identical to that previously described for the first mode with reference to FIG. 5, it will not be described again in greater detail.

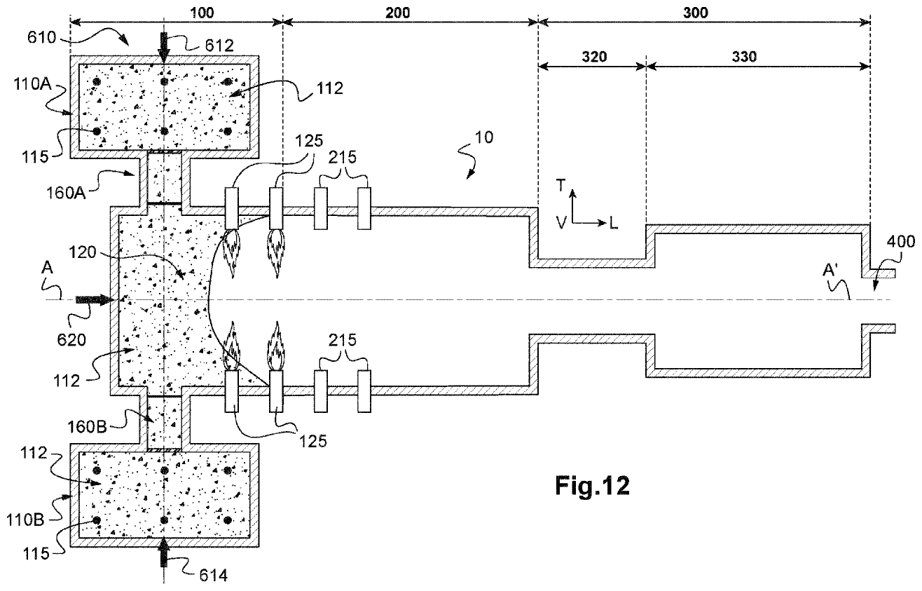

FIG. 12 shows the hybrid furnace 10 according to the second embodiment of the invention in the second hybrid operating mode wherein melting of the vitrifiable mixture is carried out jointly in said first and second electric melting zones 110A and 110B as well as in the flame melting zone 120.

As shown in FIG. 12, the two electric melting zones 110A and 110B and the flame melting zone 120 are covered with a layer 112 of vitrifiable mixture.

The first 110A and second 110B electric melting zones are each supplied by the first 612 and second 614 batch chargers, respectively, while the flame melting zone 120 is supplied longitudinally by the second charging device 620 upstream of the hybrid furnace 10.

In this hybrid operating mode, part of the molten glass produced by the first 110A and second 110B electric melting zones is therefore obtained with electricity, while the other part is obtained with a fuel used in the overhead burners 125 to produce the flames shown in FIG. 12.

In contrast to the first embodiment, the third embodiment of flame melting operation has not been shown in a figure.

In comparison with FIG. 12 above, the flame melting operating mode is distinguished by the fact that melting is achieved by means of overhead burners 125, here solely by said burners 125 in the absence of boosting electric heating means, without using the first 110A and second 110B electric melting zones.

The first embodiment shown in FIGS. 1 to 7 and the second embodiment shown in FIGS. 8 to 12 are given only as non-limiting examples of the present invention.

The invention relates to a hybrid furnace 10 for producing glass, in particular for supplying a float unit, said hybrid furnace 10 with longitudinal axis (A-A′) further comprising:
at least one electric melting zone 110 comprising electrodes 115 which is suitable for being supplied with a vitrifiable mixture by a first charging device 610;
a flame melting zone 120 comprising at least overhead burners 125 which can be supplied with vitrifiable mixture by a second charging device 620, separate from said at least one first charging device 610,
wherein said at least one electric melting zone 110 and the flame melting zone 120 arranged in series are configured to be operable independently of one another so as to allow selective use of either or both of said melting zones 110, 120, thereby providing the furnace 10 with energy flexibility.

Advantageously, the hybrid furnace 10 according to the invention is able to supply a float glass unit (not shown).

According to another aspect, the invention relates to an assembly for the manufacture of flat glass comprising a hybrid glass manufacturing furnace 10 and a float glass unit on a bath of molten metal which, arranged downstream, is supplied with glass by said furnace 10 via said at least one flow channel 400.

According to yet another aspect, the invention relates to a method of producing glass that is implemented in a hybrid furnace 10 according to the invention, in particular for supplying a float glass unit on a molten metal bath.

Said method of producing glass comprises at least one melting step carried out in the hybrid furnace 10 operating according to one of the modes of operation of said hybrid furnace described above, that is, selectively chosen from:
a first electric melting operating mode wherein molten glass is produced solely by said at least one electric melting zone 110;
a second hybrid operating mode wherein molten glass is produced jointly by said at least one electric melting zone 110 and by said flame melting zone 120;
a third flame melting operating mode wherein molten glass is produced solely by said at least one flame melting zone 120.

Advantageously, prior to implementation of the melting step in the hybrid furnace, the method of producing glass comprises at least one operating mode determination step consisting in selecting one of said furnace operating modes based on at least one selection parameter such as an economic criterion and/or an ecological criterion and/or at least one technical criterion, respectively, described above.

Thus, said determination step consists in selecting one of said operating modes based on at least one selection parameter comprising:
an economic criterion which is based on the respective cost of the electrical energy and the fuel further used to melt the vitrifiable mixture;
an ecological criterion which is based on the carbon footprint (CO2) respectively associated with the electrical energy and said fuel, and
at least one technical criterion that is based on the pull rate to be produced in relation to the quantity of molten glass that can be obtained by means of said at least one electric melting zone 110 and/or flame melting zone 120 and/or based on the composition of the glass to be produced, or even of the cullet content of the vitrifiable mixture.

Advantageously, said determination step for selecting one of the operating modes of the hybrid furnace 10 is performed by means of the control unit (UC) associated with the hybrid furnace 10.

Advantageously, when the second hybrid operating mode is selected at the end of the determination step, the method comprises an additional determination step consisting in then determining the quantity of molten glass to be produced respectively by said at least one electric melting zone 110 and by the flame melting zone 120 in order to obtain the desired pull rate.

Said further determination step also determines the respective contribution of said at least one electric melting zone 110 and the flame melting zone 120, for example a ratio of 50/50 or even a ratio of 80/20 when electric energy 5 is preferred over fuel.

Preferably, said desired pull rate is equal to the nominal pull rate of hybrid furnace 10.

Advantageously, the control unit (UC) determines the control parameters of the corresponding furnace, in particular those of the electrodes 115 and/or the overhead burners 125, but also those of the first charging device 610 and/or the second charging device 620, in order to regulate the quantity of vitrifiable material to be charged into said at least one electric melting zone 110 and/or into the flame melting zone 120 according to the operating mode of the furnace and to obtain said pull rate.

1. A hybrid furnace for producing glass, said hybrid furnace having a longitudinal axis comprising:
at least one electric melting zone which is suitable for being supplied with a vitrifiable mixture by at least one first charging device and which comprises electrodes (115) for melting said vitrifiable mixture;
a flame melting zone which, separate from said at least one electric melting zone, is suitable for being supplied with a vitrifiable mixture by at least one second charging device and which comprises at least overhead burners for melting said vitrifiable mixture, said overhead burners being arranged above the surface of the molten glass,
wherein said at least one electric melting zone and said flame melting zone are arranged in series so that the molten glass produced by one of said upstream melting zones is capable of flowing into the other of said downstream melting zones, and wherein said at least one electric melting zone and said flame melting zone are configured to operate independently of one another so as to allow selective use of one and/or the other of said melting zones in order to provide the furnace with energy flexibility,
a refining zone for molten glass delivered by said at least one electric melting zone and/or said flame melting zone, said refining zone being configured to include a first convection loop and a second convection loop; and
a zone for cooling the glass including a conditioning tank which is passed through by the second convection loop and which is connected to at least one glass flow channel.

2. The furnace according to claim 1, wherein said at least one electric melting zone is able to deliver a maximum pull rate which is less than or equal to the nominal pull rate of the furnace, that is, between 0% and 100% of the nominal pull rate.

3. The furnace according to claim 1, wherein the electrodes are arranged on the surface so as to be immersed into the vitrifiable mixture.

4. The furnace according to claim 1, wherein said flame melting zone is passed through by the first convection loop of the refining zone.

5. The furnace according to claim 1, wherein said flame melting zone is able to deliver a maximum pull rate that is less than or equal to the nominal pull rate of the furnace, that is, between 0 and 100% of the nominal pull rate.

6. The furnace according to claim 5, wherein the flame melting zone extends, along the longitudinal axis of the furnace, over a length which further determines the maximum pull rate that can be produced by said flame melting zone.

7. The furnace according to claim 1, wherein said at least one electric melting zone is connected by a tank neck to said flame melting zone.

8. The furnace according to claim 7, wherein the hybrid furnace comprises a non-return separation device which, arranged at the tank neck, is able to prevent a return of molten glass from said flame melting zone to said at least one electric melting zone.

9. The furnace according to claim 8, wherein said separation device comprises a dam intended to be partially immersed in the molten glass.

10. The furnace according to claim 8, or wherein said separation device comprises at least one elevation of a floor of the tank neck.

11. The furnace according to claim 7, wherein the hybrid furnace comprises at least one atmospheric separation means which, arranged at the tank neck is able to separate the atmosphere from said at least one electric melting zone with a cold top and the atmosphere of the flame melting zone with a hot top.

12. The furnace according to claim 7, wherein the hybrid furnace comprises immobilizing means which are able to retain the vitrifiable mixture in said at least one electric melting zone so that said vitrifiable mixture present on the surface of the glass does not penetrate into the tank neck.

13. The furnace according to claim 7, wherein the hybrid furnace comprises means for cooling the glass which are able to cool the glass in the tank neck.

14. The furnace according to claim 7, wherein the hybrid furnace comprises an electric melting zone said electric melting zone being connected to the downstream flame melting zone by a tank neck.

15. The furnace according to claim 14, wherein the first charging device for supplying vitrifiable mixture to said electric melting zone is configured to spread the vitrifiable mixture in a uniform layer over the surface of the molten glass.

16. The furnace according to claim 14, wherein the second charging device for supplying vitrifiable mixture to said flame melting zone comprises a first batch charger and a second batch charger which are arranged transversely on both sides of said flame melting zone.

17. The furnace according to claim 7, wherein the hybrid furnace comprises at least a first electric melting zone and a second electric melting zone, the first electric melting zone and the second electric melting zone being respectively connected to the flame melting zone by a first tank neck and by a second tank neck.

18. The furnace according to claim 17, characterized wherein the first electric melting zone and the second electric melting zone are arranged transversely on both sides of the flame melting zone.

19. The furnace according to claim 17, wherein said first charging device comprises a first batch charger for supplying vitrifiable mixture to the first electric melting zone and a second batch charger for supplying vitrifiable mixture to the second electric melting zone.

20. The furnace according to claim 17, wherein the second charging device is arranged longitudinally upstream of the flame melting zone.

21. The furnace according to claim 1, wherein the vitrifiable mixture introduced into the furnace by the first charging device associated with said at least one electric melting zone and the vitrifiable mixture introduced into the furnace by the second charging device associated with said flame melting zone have a similar composition.

22. The furnace according to claim 1, wherein the hybrid furnace is able to operate according to several operating modes, said furnace operating mode being selectively chosen from:
a first electric melting operating mode wherein molten glass is produced solely by said at least one electric melting zone;
a second hybrid operating mode wherein molten glass is produced jointly by said at least one electric melting zone and by said flame melting zone;
a third flame melting operating mode wherein molten glass is produced solely by said at least one flame melting zone.

23. The furnace according to claim 22, wherein the hybrid furnace is capable of being controlled by an associated control unit to select one of said operating modes based on at least one selection parameter comprising:
an economic criterion which is based on the respective cost of the electrical energy and the fuel further used to melt the vitrifiable mixture;
an ecological criterion which is based on the carbon footprint respectively associated with the electrical energy and said fuel, and
at least one technical criterion that is based on the pull rate to be produced in relation to the quantity of molten glass that can be obtained by means of said at least one electric melting zone and/or flame melting zone respectively, and/or based on the composition of the glass to be produced, or even of the cullet content of the vitrifiable mixture.

24. The furnace according to claim 1, wherein the first convection loop and the second convection loop are separated by an inversion zone of the loops determined by a hot spot or source corresponding to the hottest point of the glass and in that the refining zone comprises at least one burner which is arranged to obtain said hot spot determining said loop inversion zone wherein a ridge is arranged.

25. The furnace according to claim 1, wherein the conditioning tank of the cooling zone comprises, from upstream to downstream, a tank neck then a working end

26. A method for producing glass implemented in a hybrid furnace according to claim 1, said method comprising at least one melting step carried out in the hybrid furnace operating according to an operating mode of said furnace chosen selectively from:
a first electric melting operating mode wherein molten glass is produced solely by said at least one electric melting zone;
a second hybrid operating mode wherein molten glass is produced jointly by said at least one electric melting zone and by said flame melting zone;
a third flame melting operating mode wherein molten glass is produced solely by said at least one flame melting zone.

27. The method for producing glass according to claim 26, comprising, prior to implementing the melting step in the furnace, a determination step for selecting one of said operating modes based on at least one selection parameter comprising:
an economic criterion which is based on the respective cost of the electrical energy and the fuel further used to melt the vitrifiable mixture;
an ecological criterion which is based on the carbon footprint respectively associated with the electrical energy and said fuel, and
at least one technical criterion that is based on the pull rate to be produced in relation to the quantity of molten glass that can be obtained by means of said at least one electric melting zone and/or flame melting zone and/or based on the composition of the glass to be produced, or even of the cullet content of the vitrifiable mixture.

28. The method for producing glass according to claim 27, wherein said step of determining the operating mode of the hybrid furnace is carried out by means of a control unit which, associated with the hybrid furnace enables it to be controlled.
